(19) United States
(12) Patent Application Publication
(10) Pub. No.: US 2026/0353067 A1
(43) Pub. Date: Nov. 5, 2026

(54) SYSTEM AND METHOD FOR UE CAPABILITY/CAPACITY REPORTING FOR AI/ML-ENABLED FUNCTIONALITIES IN WIRELESS SYSTEMS

(71) Applicant: Huawei Technologies Co., Ltd., Shenzhen (CN)

(72) Inventors: Chunhui Zhu, Inverness, IL (US); Baoling S. Sheen, Overland Park, KS (US); Weimin Xiao, Hoffman Estates, IL (US); Zhigang Rong, San Diego, CA (US)

(21) Appl. No.: 19/662,888

(22) Filed: Apr. 29, 2026

Related U.S. Application Data
(63) Continuation of application No. PCT/US2024/054226, filed on Nov. 1, 2024.
(60) Provisional application No. 63/596,082, filed on Nov. 3, 2023.

(51) Int. Cl. H04W 8/24

(52) U.S. Cl. CPC H04W 8/24

(57) ABSTRACT

In this disclosure, apparatuses, systems, and non-transitory computer-readable storage media are provided. A method includes: receiving, from a network controller, a configuration message associated with reporting of a user equipment (UE) capability related to at least one artificial intelligence (AI)/machine learning (ML) model or at least one AI/ML-enabled functionality; deriving a first value of first resource amount of a first resource type required for at least a first AI/ML model or at least a first AI/ML-enabled functionality in accordance with the configuration message; and reporting, to the network controller, the first value.

### PRIORITY CLAIM AND CROSS-REFERENCE

This patent application is a continuation of International Application No. PCT/US2024/054226, filed on Nov. 1, 2024 and entitled “System and Method for UE Capability/Capacity Reporting for AI/ML-enabled functionalities in Wireless Systems,” which claims priority to U.S. Provisional Application No. 63/596,082, filed on Nov. 3, 2023 and entitled “System and Method for UE Capability/Capacity Reporting for AI/ML-enabled functionalities in Wireless Systems,” both of which are hereby incorporated by reference herein as if reproduced in their entirety.

### TECHNICAL FIELD

The present invention relates generally to managing the allocation of resources in a network, and in particular embodiments, to techniques and mechanisms for UE capability/capacity reporting for artificial intelligence (AI)/machine learning (ML)-enabled functionality.

### BACKGROUND

Data collection is a first step for enabling the application of AI/ML for multiple purposes, including model training, model inference, and performance monitoring. Capabilities and/or capacities of a particular device are desired to be known to configure the device appropriately for such purposes. Challenges may arise when attempting to access data of a particular device.

Embodiments of the present disclosure include methods, devices, systems, and non-transitory computer-readable storage media device for capability/capacity reporting for AI/ML-enabled functionalities in wireless systems.

### SUMMARY OF THE INVENTION

Technical advantages are generally achieved, by embodiments of this disclosure which describe UE capability/capacity reporting for AI/ML-enabled functionalities in wireless systems.

In accordance with a first aspect of the disclosure, a method is provided. The method includes receiving, by the wireless device from a network controller, a configuration message associated with reporting of a user equipment (UE) capability related to at least one AI/ML model or at least one AI/ML-enabled functionality. The method further includes deriving, by the wireless device, a first value of first resource amount of a first resource type required for a first AI/ML model or a first AI/ML-enabled functionality in accordance with the configuration message. The method further includes reporting, by the wireless device to the network controller, the first value.

In some implementations, the first value includes a relative value of the first resource type available in the wireless device.

In some implementations, the first value includes a percentage or a portion of the first resource amount of the first resource type available in the wireless device.

In some implementations, the first value of the first resource amount of the first resource type required for the first AI/ML model or the first AI/ML-enabled functionality includes a number of MPUs associated with the first resource type available in the wireless device.

In some implementations, the first resource type includes at least one of computational power, memory, storage, or a battery level.

In some implementations, the configuration message includes a radio resource control (RRC) configuration message.

In some aspects, the first AI/ML model represents a model group including a set of models to be inferenced together to support another AI/ML-enabled functionality or the first AI/ML-enabled functionality is associated with a model group including a set of models to be inferenced together to support the first AI/ML-enabled functionality.

In some implementations, the first resource type indicates a compound resource of a plurality of relevant resource types associated with the wireless device.

In some implementations, the method includes deriving, by the wireless device, a resource occupation time associated with the first value, and reporting the resource occupation time to the network controller.

In some implementations, the method includes receiving, by the wireless device from the network controller, a resource occupation timeline associated with the first value.

In some implementations, the method includes receiving, by the wireless device from the network controller, a scheduling of model inference for the at least one AI/ML model or the at least one AI/ML-enabled functionality based on a resource occupation timeline associated with the first value.

In some implementations, the method includes deriving, by the wireless device, a second value of second resource amount of a second resource type required for the first AI/ML model or the first AI/ML-enabled functionality, and reporting, by the wireless device to the network controller, the second value.

In some implementations, the method includes deriving, by the wireless device, a third value of third resource amount of the first resource type available for another AI/ML model or another AI/ML-enabled functionality, and reporting, by the wireless device to the network controller, the third value.

In some implementations, the method includes receiving, by the wireless device, an indication to perform model inference of the first AI/ML model or the first AI/ML-enabled functionality. The example method may further include determining, by the wireless device, that there are enough resources of the first resource type available to perform the model inference of the first AI/ML model or the first AI/ML-enabled functionality. The method may further includes in response to determining that there are enough resources of the first resource type available, performing, by the wireless device, the model inference of the first AI/ML model or the first AI/ML-enabled functionality.

In some implementations, the method includes dropping, by the wireless device, a second AI/ML model or a second AI/ML-enabled functionality based on a first priority associated with the first AI/ML model or the first AI/ML-enabled functionality and priorities of other AI/ML models or other AI/ML-enabled functionalities.

In some implementations, the method includes falling back, by the wireless device, to a non-AI/ML-based feature of the second AI/ML model or the second AI/ML-enabled functionality.

In some implementations, the method includes determining, by the wireless device, that an available resource amount of the first resource type is below the first resource. Further in the method, the example method further includes rejecting, by the wireless device and in response to determining that the available resource amount of the first resource type is below the first resource amount, a delivery of the first AI/ML model or the first AI/ML-enabled functionality.

In some implementations, the reporting is performed in accordance with a periodic reporting mechanism, an even-triggered reporting mechanism, an on-demand reporting mechanism, or a UE-initiated reporting mechanism.

In some implementations, reporting the first value includes reporting, by the wireless device to the network controller, a plurality of resource occupation times associated with a plurality of values of the first resource type for the at least one AI/ML model or the at least one AI/ML-enabled functionality, where each resource occupation time of the plurality of resource occupation times indicates an amount of time that a resource of the first resource type is utilized at corresponding value of the plurality of values of the first resource type, and where the plurality of values includes the first value.

In accordance with a second aspect of the disclosure, a method is provided. The example method includes sending, by the network controller to a wireless device, a configuration message associated with reporting of a UE capability related to at least one AI/ML model or at least one AI/ML-enabled functionality. The method further includes receiving, by the network controller from the wireless device, a report of a first value of first resource amount of a first resource type required for a first AI/ML model or a first AI/ML-enabled functionality in accordance with the configuration message. The method further includes determining, by the network controller based on the report of the first value, whether to perform a model inference of the first AI/ML model or the first AI/ML-enabled functionality. The method further include sending, by the network controller to the wireless device, an indication to perform the model inference of the first AI/ML model or the first AI/ML-enabled functionality.

In some implementations, the method includes receiving, by the network controller from the wireless device, a report of an available resource amount of the first resource type associated with the wireless device. Determining whether to perform the model inference of the first AI/ML model or the first AI/ML-enabled functionality is based on the report of the available resource amount of the first resource type associated with the wireless device.

In some implementations, the first value includes a relative value of the first resource type available in the wireless device.

In some implementations, the first value of includes a percentage or a portion of the first resource amount of the first resource type available in the wireless device.

In some implementations, the first value includes a number of MPUs associated with the first resource type available in the wireless device.

In some implementations, the first resource type includes computational power, memory, storage, or a battery level.

In some implementations, the configuration message includes at least one radio resource control (RRC) configuration message.

In some implementations, the first AI/ML model represents a model group including a set of models to be inferenced together to support another AI/ML-enabled functionality or the first AI/ML-enabled functionality is associated with a model group including a set of models to be inferenced together to support the first AI/ML-enabled functionality.

In some implementations, the first resource type indicates or refers to a compound resource of a plurality of relevant resource types associated with the wireless device.

In some implementations, determining whether to perform the model inference of the first AI/ML model or the first AI/ML-enabled functionality includes determining, by the network controller based on the report of the first value, that the wireless device has more available resources than the first value.

In some implementations, the method includes determining whether to perform the model inference of the first AI/ML model or the first AI/ML-enabled functionality includes determining, by the network controller based on the report of the first value, that the first value is not within an allowed value of the first resource type for the wireless device.

In some implementations, the method includes deriving, by the network controller, a resource occupation timeline associated with the first value, where determining whether to perform the model inference of the first AI/ML model or the first AI/ML-enabled functionality is further based on the resource occupation timeline.

In some implementations, the method includes receiving, by the network controller from the wireless device, a report of a second value of second resource amount of a second resource type required for the first AI/ML model or the first AI/ML-enabled functionality, where determining whether to perform the model inference of the first AI/ML model or the first AI/ML-enabled functionality is further based on the report of the second value.

In some implementations, where the first AI/ML model or the first AI/ML-enabled functionality is associated with a first priority, the method further includes determining, by the network controller, to drop a second AI/ML model or a second AI/ML-enabled functionality based on a second priority associated with the second AI/ML model or the second AI/ML-enabled functionality and the first priority associated with the first AI/ML model or the first AI/ML-enabled functionality. The method further includes sending, by the network controller to the wireless device, an indication to drop the second AI/ML model or the second AI/ML-enabled functionality.

In accordance with another aspect, an apparatus is provided. The apparatus includes at least one processor, and at least one non-transitory computer readable storage medium storing instructions, where the at least one non-transitory computer readable storage medium and the instructions are configured, with the at least one processor, to cause the apparatus to perform any of the e methods described herein.

In accordance with another aspect, a system is provided. The system includes a plurality of devices, each including at least one processor and at least one non-transitory computer-readable storage medium, the plurality of devices configured to perform any one of the methods described herein.

In accordance with another aspect, at least one non-transitory computer-readable storage medium is provided. The at least one non-transitory computer-readable storage medium stores instructions that, in execution with at least one processor, is configured to perform any one of the methods described herein.

### BRIEF DESCRIPTION OF THE DRAWINGS

For a more complete understanding of the present disclosure, and the advantages thereof, reference is now made to the following descriptions taken in conjunction with the accompanying drawings according to at least some embodiments of the present disclosure, in which:

FIG. 1 illustrates an example system diagram of a cellular network in which AI/ML-enabled functionalities may be deployed;

FIG. 2 illustrates an example diagram of a user equipment;

FIG. 3 illustrates an example flowchart of a first part of network behavior when relative value approach is used;

FIG. 4 illustrates an example flowchart of a second part of network behavior when relative value approach is used;

FIG. 5 illustrates an example flowchart of a first part of user equipment behavior or other wireless device behavior when relative value approach is used;

FIG. 6 illustrates an example flowchart of a second part of user equipment behavior or other wireless device behavior when relative value approach is used;

FIG. 7 illustrates an example flowchart of network-user equipment communications, for example when a relative value approach is used;

FIG. 8 illustrates an example flowchart of a first part of network behavior when absolute value approach is used;

FIG. 9 illustrates an example flowchart of a second part of network behavior when absolute value approach is used;

FIG. 10 illustrates an example flowchart of a first part of user equipment behavior or other wireless device behavior when absolute value approach is used;

FIG. 11 illustrates an example flowchart of a second part of user equipment behavior or other wireless device behavior when absolute value approach is used;

FIG. 12 illustrates network-user equipment communications, for example when an absolute value approach is used;

FIG. 13 illustrates an example communications system;

FIG. 14 illustrates another example communications system;

FIG. 15A illustrates an example device;

FIG. 15B illustrates another example device;

FIG. 16 illustrates a block diagram of another example computing system;

FIG. 17 illustrates a diagram of operations of an example method for reporting at least a value of an amount of a resource type, ;

FIG. 18 illustrates a diagram of operations of an example method for reporting a value of an amount of a resource type available;

FIG. 19 illustrates a diagram of operations of an example method for initiating performance of a model inference;

FIG. 20 illustrates a diagram of operations of an example method for dropping and/or falling back from use of an AI/ML-enabled functionality and/or an AI/ML-enabled functionality;

FIG. 21 illustrates a diagram of operations of an example method for rejecting delivery of an AI/ML model or AI/ML-enabled functionality;

FIG. 22 illustrates a diagram of operations of reporting resource occupation time/resource occupation timeline;

FIG. 23 illustrates a diagram of operations of initiating performance of model inference using capacity/capability reporting;

FIG. 24 illustrates a diagram of operations of determining whether an amount of a resource type is within an allowed value for that resource type; and

FIG. 25 illustrates a diagram of initiating dropping and/or falling back from use of an AI/ML model and/or an UI-enabled function for sending an indication to drop at least one AI/ML model or AI/ML-enabled functionality.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENT

The following represents abbreviations utilized in the disclosure:
Artificial intelligence (AI)
AI/ML processing unit (APU)
Machine learning (ML)
Physical layer (PHY)
Study item (SI)
Channel state information (CSI)
Central processing unit (CPU)
Next-generation node B (gNB, e.g., a base station)
Media access control-control element (MAC-CE)
Machine-learning processing unit (MPU)
Neural processing unit (NPU)
Network (NW)
Graphics processing unit (GPU)
Operating system (OS)
Physical Uplink Control Channel (PUCCH)
Radio access network (RAN)
Radio resource control (RRC)
User equipment (UE)

In this disclosure, reference words such as “first,” “second,” and the like are used to provide a label to refer to a particular term. The use of such reference words is intended to allow for distinguishing between such terms without any additional meaning. In this regard, unless otherwise specified, the use of “first,” “second,” and the like do not suggest any priority, sequence ordering, importance, or any other meaning regarding such terms. It should be appreciated that a “first” of an item and a “second” of an item from a set may be the same item in some circumstances, or distinct items in some circumstances.

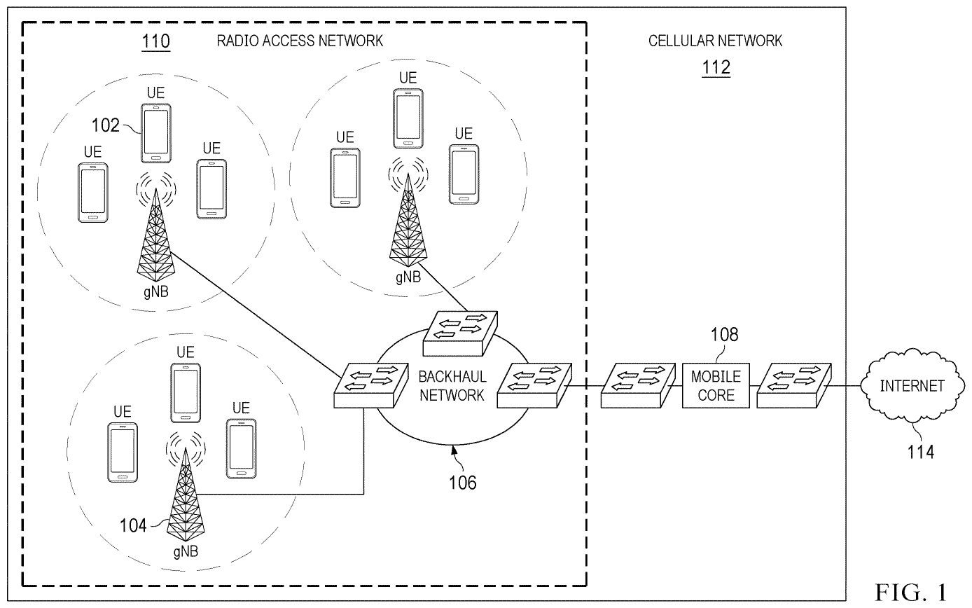

This disclosure is related to the application of artificial intelligence/machine learning (AI/ML) in cellular networks. FIG. 1 depicts an illustration of such a network, for example a system diagram of a cellular network.

In 3GPP RAN1 Release 18, a study item (FS_NR_AIML_Air) was established to apply AI/ML to solve PHY layer problems. In particular, this SI targets three use cases, e.g., CSI compression, beam management, and positioning.

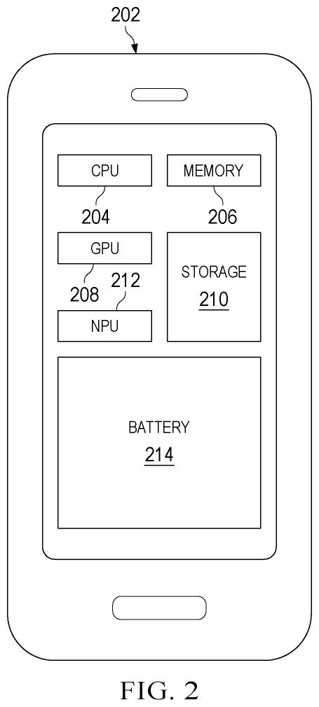

Data collection is the first step for enabling the application of AI/ML for multiple purposes including model training, model inference, and performance monitoring. Among the information needed to be collected, one important aspect is the capability or capacity of a UE, for example UEs 102, as each UE may have a different level of support of AI/ML, which is determined by its capability or capacity (such as computing power, memory, storage space, and the like). This type of information is sometimes referred to as assistance information or meta information. Furthermore, performing AI/ML-enabled functionalities may utilize more computing power and memory comparing traditional methods. For the network controller, such as a gNB (for example, gNBs 104 connected to backhaul network 106), base station, and TRP, to properly configure a UE to perform an AI/ML-enabled functionality, it needs to know whether the UE has enough resources (for example, computing power and memory) for such tasks. In some embodiments, the backhaul network 106 connects to a mobile core 108, which provides access to the Internet 114. The UEs 102, gNBs 104, and backhaul network 106 represent a Radio Access Network 110, and the Radio Access Network 110 in combination with the mobile core 108 represent a Cellular Network 112 enabling access to the Internet 114. FIG. 2 depicts an example diagram of a user equipment (UE), specifically a UE 202. The example UE 202 has various components defining capabilities and/or capacities of the UE 202. For example, as depicted, the UE 202 includes a CPU 204, Memory 206, GPU 208, Storage 210, NPU 212, and a battery 214.

To enable the collection of data and assistance/meta information, both sides of the communications link (e.g., the network/gNB and the UE) may need to inform the other side of its capabilities/capacities. In this disclosure, we cover the case where UE reports its capability/capacity to the NW. There are many cases how this information can be utilized.

As one example, if a UE is to collect data from the network, it needs to let the network know whether it is able to store the data it is requesting.

As another example, when inference (and even model training if federated learning is used) is to be performed in the UE, the computing power available in the UE may need to be made known to the network so a proper model can be transferred/delivered to the UE for execution.

As a third example, when a trained model is going to be delivered/transferred from NW to UE, it is important for the NW to know that the UE has enough space to store the model at the UE.

The reported capability and capacity can be multi-dimensional, for example, the available storage space and the computing power in the network/UE (e.g., or any other resource type). Alternatively, a single capability value may be reported to represent the overall capability (for example, computing and memory, and the like) of the UE supporting AI/ML-enabled functionalities. Alternatively, the reported capability and capacity can represent the UE's capability and capacity supporting both AI/ML-enabled functionalities and traditional (non-AI/ML-enabled) functionalities.

This disclosure includes identification of UE's capabilities/capacities required for supporting AI/ML applications in the field of wireless communications. This disclosure further designs different ways for measuring UE's various capabilities/capacities. This disclosure further designs mechanisms for a UE to report the required and/or available capability/capacity information to the network so that the network can have a good estimation/assessment of the UE-side resource for AI/ML model inference. The term “required” should be construed in a non-limiting manner, such that “requested”, “measured”, “associated” could also be used in alternative embodiments. Each of these terms can be used to describe the reported values.

One or more UE capability and capacity may be measured and reported. Each UE capability and capacity, in some embodiments, may be classified into two categories in this disclosure, high-priority and low priority.

The following includes examples of high-priority and low priority categories. In some embodiments, the high-priority and/or low-priority items include any more or more of:

Computational power, which determines whether a model can be inferenced (or even trained) at a UE.

Memory, which determines the number of models can be run and/or perform inference at the same time at a UE (e.g., together with the computational power).

Storage, which determines whether enough space is available in the UE for storing a model.

Model Inference Time (duration), which determines whether model inference can be done within the required duration; failure in this measurement could result in model deactivation, switching to other models or fallback to traditional approaches (e.g. non-AI/ML approaches). This information can also be used to obtain the resource occupation cycle of the UE for improving the scheduling of AI/ML model inference. A model inference time may be defined a resource occupation time (or timeline) in some embodiments.

The following includes an example of a low-priority item.

Battery level, which determines whether battery capacity is enough for model inference (or training).

From the UE perspective, capacities can be nominal values, available values at certain time after performing other tasks, reserved values for certain tasks or functionalities, or requested values of the amount needed to perform certain task or functionality. Therefore, all the above can be dynamic. For UE reporting, available/reserved values and requested values are more relevant for network controller decision making.

UE capability/capacity measurement faces various challenges. For example, measuring the UE capability/capacity in a dynamic manner is challenging in that:

First, a UE's hardware and implementation details are not (fully) visible (or controllable) outside of the devices. To address this issue, the measurement of the capabilities/capacities need to have wide range of applicability and practicality; it should provide certain level of abstraction of the resources to be measured.

Second, some measurements, such as computational power, is difficult to align between UE and NW and between UEs. As an example, Device A's 10% may be different from Device B's 10% because their capability of computation is different. The same model takes 10% computing power of Device A may be equivalent to only 5% computing power of Device B. One of the reasons for this is that the latest UEs could have various architecture of computation engines (CPU, GPU, NPU, and the like). To address this issue, some type of measurement results (e.g., relative measurement mentioned later) may only be meaningful when attached to a specific UE. Also due to mixture of computation engines and multiple levels of memory, even for a specific UE/device, a measure of computation power and memory is not straightforward and highly depends on the UE implementation.

Third, there may be multiple functionalities/models at the UE side and even more functionalities/models to control at the Network side. To address this issue, models/model groups can be ranked at different priority levels and the UE should be able to deactivate the inference of low-priority models and fallback to traditional non-resource-hungry approaches when needed.

Fourth, the measurement needs to deal with time-varying situations/combinations. The situation of resource utilization within a UE varies over time, affected by many aspects, including the resources occupied by system and other applications. At some point, resources may be scarcer while at other points they may be abundant. This continuously changing environment requires the reporting to be performed in a dynamic manner.

### Overview of Capability/Capacity Measurements

The disclosure covers different types of capability/capacity measurements. Three different types of capability/capacity measurements in further detail. It should be appreciated that these different types of capability/capacity measurements are non-limiting examples and other such example types of capability/capacity measurements may fall within the scope of the disclosure herein.

A first type of capability/capacity measurements is a measurement by relative values. With this approach, each model running on a UE is measured by the portion/percentage of resources it utilizes, such as the percentage of computing power, memory and storage space. This step may be performed offline in the manufacturing facility or online for example after an AI/ML model is made available at the UE device.

As an example, the portion/percentage of resource needed for each model to inference is recorded and reported to the network. Performing an AI/ML model inference in some embodiments includes any process of using a trained AI/ML model to produce a set of outputs based on a set of inputs, for example performed on a wireless device (e.g., a UE) as part of measuring values associated with resources of one or more resource types during such performance on the wireless device. The measurement of resource utilization and the derivation of report to the network can be a UE implementation in some embodiments.

The network estimates/controls the AI/ML-enabled functionalities or models to run in the UE to make sure the total portion/percentage will not exceed the allowed/reserved portion/percentage, e.g., 50% (for example, where this is also reported from the UE to the NW). The UE follows the network controller configuration to carry these functionalities as long as the required total resources portion/percentage is within the allowed/reserved portion/percentage according to the UE capability reports.

A second type of capability/capacity measurements is a measurement by absolute values. With this approach, the resource is measured by its absolute value. For example, for computational power, the measurement result can be represented as the number of floating-point operations per second (FLOPS). For memory and storage, the measurement result can be represented by the size of memory/storage in Mega Bytes (MBs).

The network estimates/controls the number of models to run in the UE to make sure the combined computational power will not exceed the maximum capability/capacity allowed or reserved (e.g., resources are also allocated to non-AI/ML tasks).

A third type of capability/capacity measurements is a measurement by a reference processing power. As an example, this approach may apply only to computational power. As an alternative, the approach can apply to all relevant types of resources including computational power, memory, and the like.

In this approach, the concept of Machine-Learning Processing Unit (MPU) is introduced to present the UE's capability for AI/ML model inference, as well as the demand of computational power (and memory) of each model, measured as the number of MPUs (N_{MPU}). In some contexts, an MPU may be alternatively referred to as an AI/ML processing unit (APU).

The UE reports N_{MPU} it can support at the time of reporting and the NW controls, based on this information, whether a model can be inferenced at the UE.

The NW configurations and UE measurement reports can be sent using L1 channel such as PUCCH, or MAC-CE, or RRC signaling, or new signaling designed for AI/ML. In this disclosure, we use RRC signaling as an example. It should be appreciated that in other embodiments, non-RRC implementations may be used within the bounds and scope of this disclosure and the attached amendments.

### Measurement and Report by Relative Values

In this approach, the portion/percentage of certain resource it takes for each model/functionality to run (e.g., inference) over the total available resource is measured, instead of the absolute numbers measured. For example, a model may take about 5% of the computational power and 10% of memory of a UE to inference.

Note that the measurement of the portion/percentage may be implementation-specific and/or done completely offline. It is hence not visible to standards. The way the portion/percentage is calculated and obtained in some embodiments is up to the UE implementation.

In one embodiment, the report of required resource for an AI/ML model or an AI/ML-enabled functionality is in percentage of the total resource(s) that may be utilized by the AI/ML model or the AI/ML-enabled functionality. In another embodiment, the report of required resource for an AI/ML model or an AI/ML-enabled functionality is in portion of the total resource(s) that may be utilized by the AI/ML model or the AI/ML-enabled functionality, for example, m out of total n parts of resource(s), where n and m are integers and m≤n.

In one embodiment, the total resource(s) that may be utilized by the AI/ML model or the AI/ML-enabled functionality is all the relevant resources in the device that may potentially be used for the AI/ML model or the AI/ML-enabled functionality. The reported percentage/portion is then the percentage/portion of the required resource for the AI/ML model or the AI/ML-enabled functionality over all the relevant resources in the device that may potentially be used for the AI/ML model or the AI/ML-enabled functionality. The advantage of such an embodiment is that the total resource(s) is quite stable and not likely to change over time. On the other hand, the resources are likely used for other functions.

In another embodiment, the total resource(s) that may be utilized by the AI/ML model or the AI/ML-enabled functionality is the reserved relevant resources in the device that may potentially be used for the AI/ML model or the AI/ML-enabled functionality. By UE implementation, the UE sets aside only a portion of its total resources for AI/ML models or AI/ML-enabled functions. The reported percentage/portion is then the percentage/portion of the required resource for the AI/ML model or the AI/ML-enabled functionality over the reserved relevant resources in the device that may potentially be used for the AI/ML model or the AI/ML-enabled functionality. Such an approach gives the UE more flexibility while the amount of resources reserved may vary in a slot time scale. It may not be visible, from outside of the UE device, the difference between the total versus reserved resources.

In yet another embodiment, the total resource(s) that may be utilized by the AI/ML model or the AI/ML-enabled functionality is the currently available relevant resources in the device that may potentially be used for the AI/ML model or the AI/ML-enabled functionality. However, the available resources may vary over time quickly and hence very dynamic reporting is required.

As the resources are often shared among the AI/ML models or the AI/ML-enabled functionalities as well as with other functions, the actual amount of resources available for the AI/ML models or the AI/ML-enabled functionalities changes over time. For the network controller to properly configure UE to perform any number of additional AI/ML model inference or AI/ML-enabled function, it needs to know the resources still available in addition to the required resources for the AI/ML model or the AI/ML-enabled function. In some embodiments, the reported percentage/portion of the required resource(s) for an AI/ML model or an AI/ML-enabled function is based on the reserved resource(s), and the network controller tracks the total percentage/portion of the reserved resource(s) already used by AI/ML models or AI/ML-enabled functions for the concerned time instance(s). The network controller then indicates the UE device accordingly concerning AI/ML models or AI/ML-enabled functions. As an example, the network controller may indicate the UE device to perform additional AI/ML model inference or AI/ML-enabled function at certain time intervals. As another example, the network controller may indicate the UE device to disable an AI/ML model or AI/ML-enabled functions. Yet another example, the network controller may indicate the UE device to fall back from using an AI/ML model or AI/ML-enabled function to a corresponding non-AI/ML based method.

In other embodiments, the UE reports currently available resource(s) (e.g., in terms of percentage/portion of the reserved resource(s)). The reported available resource(s) may be the percentage/portion of reserved resource(s) available after non-AI/ML functions. The network controller then tracks the total percentage/portion of the reserved resource(s) already used by AI/ML models or AI/ML-enabled functions for the concerned time instance(s). The network controller then indicates the UE device concerning AI/ML models or AI/ML-enabled functions according to the available percentage/portion of reserved resource(s). Alternatively, the reported available resource(s) may be the percentage/portion of reserved resource(s) available after non-AI/ML functions and the currently active/running AI/ML models and AI/ML-enabled functions. The network controller then tracks the additional percentage/portion of the reserved resource(s) used by AI/ML models or AI/ML-enabled functions onwards and indicates the UE device concerning AI/ML models or AI/ML-enabled functions according to the available percentage/portion of reserved resource(s).

In the case of multiple types of resources, such as computational power, memory, and the like, the UE may report separate capability/capacity values for those resources. For example, the UE reports one value of percentage/portion for required computational power for an AI/ML model or AI/ML-enabled function and another value of percentage/portion for required memory for the AI/ML model or AI/ML enabled-function. Correspondingly, the UE reports one value of percentage/portion for available computational power and another value of percentage/portion for available memory. The network controller tracks utilization of both resources and indicates the UE concerning AI/ML models or AI/ML-enabled functions accordingly.

In some embodiments, the UE reports a single value considering all types of relevant resources. For example, the UE reports a single value of percentage/portion for required computational power and memory for an AI/ML model or AI/ML-enabled function. Correspondingly, the UE reports a single value of percentage/portion for available computational power and memory. These relevant types of resources are treated as a single type of compound resource from outside of the UE device. The network controller tracks utilization of such a compound resource and indicates the UE concerning AI/ML models or AI/ML-enabled functions accordingly.

### Measurement and Report of Computational Power

The following describes the general procedures for the measurement and report of computational power, using the relative value approach. Detailed steps of the embodiment and the flowchart are provided below.

The NW sends RRC configuration message(s) to UE indicating the UE resources (for example, in this case, the computational power) needed to be measured/reported and optionally, the measurement approach to use.

Each model/model group may be run/inferenced at a UE to determine its computing power usage, in terms of portion or percentage of the combined processing power of all applicable processing units of the UE allocated for AI/ML model inference for wireless networks, e.g., CPU, GPU, NPU, and the like. A model group is a set of models that need to be run/inferenced together to complete a functionality. The exact way a device measures and reports the computational power is likely hidden from outside, especially with mixed types of processing units.

The portion/percentage of computational power it takes for each model to run (e.g., inference) is recorded/processed and reported to the network, using one of the reporting mechanisms provided herein.

The available portion/percentage of combined computational power of the UE may also be reported to the network, using one of the reporting mechanisms provided herein.

The network receives and records the computational power utilization of the model/functionality, as well as the total portion/percentage of computational power available.

The NW determines/controls, based on a model's requirement of computing power and reported total available computational power, whether the model can perform inference at the UE and indicates to the UE concerning AI/ML models or AI/ML-enabled functions accordingly.

The network estimates/controls which models and the number of simultaneous models that can be run in the UE to make sure the total portion/percentage of computing power will not exceed the allowed/reserved portion/percentage, e.g., 50% of the UE's total computational power (for example, resources are also allocated to non-AI/ML tasks).

In the case the combined requirements for computational power from the functionalities exceed the allowed/reserved portion/percentage allocated at the UE (e.g., at certain time instance or during a time interval), the UE can drop/deactivate some AI/ML-functionalities or fallback to traditional methods (for example, if possible). Priority among the AI/ML models or AI/ML-enabled functionalities may be defined or configured by the network controller. In the event of dropping/deactivation, the UE may report this event to the network controller. More information about priority is discussed further herein.

In some embodiments, the accuracy of measurement in portion/percentage of the resource utilizations can be improved over time whenever a model/model group is run/inferenced. This may be true for all measurement types and for all resource types.

### Measurement and Report of Memory

The following describes the general procedures for the measurement and report of UE memory utilization, using the relative value approach. Detailed steps of the embodiment and the flowchart are provided herein.

The NW sends RRC configuration message(s) to UE indicating the UE resources (in this case, the memory) needed to be measured/reported and optionally, the measurement approach to use.

Each model/model group may be run/inferenced at a UE to determine its memory occupation need as the portion/percentage of total available memory (which may be depending on the measurement approach it uses) during the inference.

The portion/percentage of memory it takes for each model/model group to run (e.g., inference) at the UE is recorded/processed and reported to the network, using one of the reporting mechanisms provided herein.

The available portion/percentage of memory may also be reported to the network, using one of the reporting mechanisms provided herein.

The network receives and records the memory utilization of the model/functionality, as well as the total portion/percentage of memory available.

The NW determines/controls, based on a model's requirement of memory and reported total available memory, whether the model can perform inference at the UE and indicates to the UE concerning AI/ML models or AI/ML-enabled functions accordingly.

The network estimates/controls which models and the number of models to run in the UE to make sure the total portion/percentage of memory usage will not exceed the allowed/reserved portion/percentage, e.g., 50% (for example, memory is also allocated to non-AI/ML tasks).

In the case the combined requirements for memory from the functionalities exceed the allowed/reserved portion/percentage allocated at the UE (e.g., at certain time instance or during a time interval), the UE can drop/deactivate some AI/ML-functionalities or fallback to traditional methods (for example, if possible). Priority among the AI/ML model or AI/ML-enabled functionalities may be defined or configured by the network controller. In the event of dropping/deactivation, the UE may report this event to the network controller. More information about priority can be found further herein.

### Measurement and Report of Storage Capacity

The following describes the general procedures for the measurement and report of UE storage utilization, using the relative value approach. Detailed steps of the embodiment and the flowchart are provided further herein.

The NW sends RRC configuration message(s) to UE indicating the UE resources (in this case, the storage) needed to be measured/reported and optionally, the measurement approach to use.

Each model/model group is downloaded/delivered to the UE to determine its storage requirements. As an alternative, the model size information can be made known to the UE via other means, such as offline provisioning or message from the network-side.

The portion/percentage of the storage space it takes to store the model/model group is recorded/processed and reported to the network, using one of the reporting mechanisms provided further herein.

The available portion/percentage of storage space may also be reported to the network, using one of the reporting mechanisms provided further herein.

The NW determines/controls, based on a model's requirement of storage space and the situation of overall storage space at the UE, whether a model can be transferred and stored at the UE. The NW may transfer/deliver the model to the UE if it determines that there is enough storage space at the UE.

In some embodiments, if the total storage space at the UE is not enough for storing the model, the NW decides what model/model group to be removed from the UE, for example if possible. Once decided, the NW communicates to the UE to indicate the model/model group to be removed.

### Reporting Strategies

The UE may apply different measurement and reporting strategies to its capability/capacity measurements, for example:

In some embodiments, the reported values may not be directly taken from the measured values. The UE can take its own optimization approaches to make the measurements more practical and accurate. For example, margin can be added, averaging over time or different situations may be done, post-processing/weighted average such as in the case of mixed processing powers can also be done.

In some embodiments, the UE, based on its strategy, can report either a tighter percentage/portion (e.g., in the extreme case, the same number as the measured/averaged number) or a percentage/portion with some cushion (e.g., adding certain percentage/margin to the measured numbers).

In some embodiments, as an alternative embodiment to measuring the resources needed to run the AI/ML model, the UE can report the extra portion/percentage of resource needed to achieve the same function as compared to if done by traditional methods.

In some embodiments, the resources allocated to a model/model group may be different every time an inference is being run on the UE as the UE's OS has the capability to assign tasks among GPU, NPU and other processing units. To address this issue, in some embodiments, the UE decides whether the measurement should be done multiple times to obtain the highest utilization of the resources. In some embodiments, the UE decides whether the peak utilization or the average utilization should be reported.

In some embodiments, the strategy can also be adjusted over time in practice to find the best measurement and reporting strategy.

In some embodiments, the NW takes whatever numbers the UE reports and makes its decisions based on them.

The above approach provides a number of advantages. Comparing to direct measurement of the absolute values of UE resources, this approach provides an abstract of UE capabilities across different hardware platforms. As a result, such embodiments hides UE's hardware details from the network, which is a desirable feature.

In addition, such embodiments unify the measurements of different UE capabilities, making it easy for protocol/signaling design by only needing to present a percentage or portion in messages.

### The Flowchart of the Relative Value Approach

Further herein, flowcharts are provided for illustrating NW behavior, UE behavior and the communications between NW and UE.

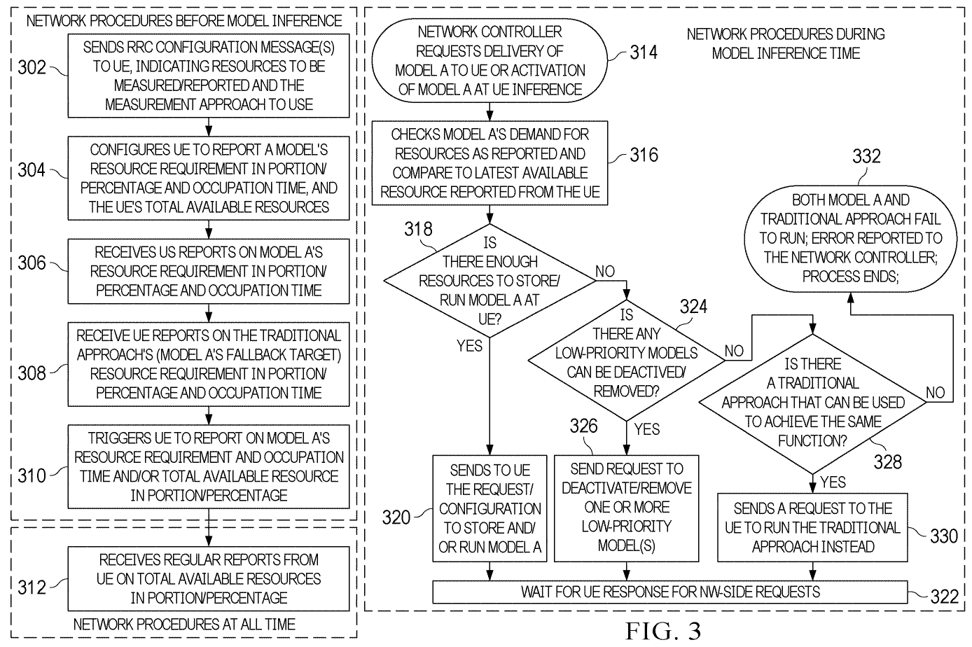

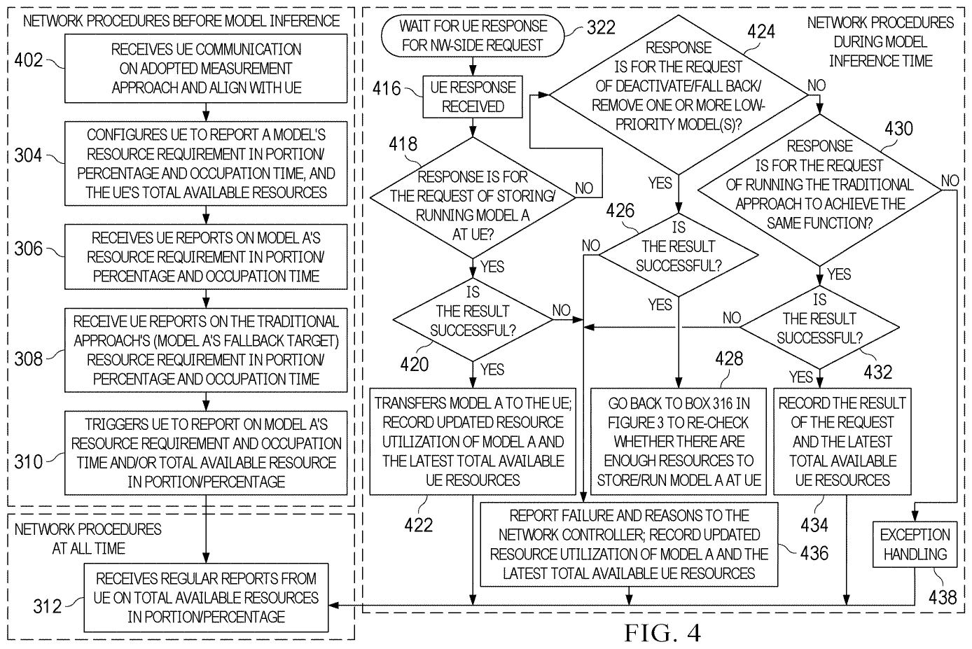

The flowchart of NW behavior is separated in two figures, FIG. 3, and FIG. 4. FIG. 3 depicts A flowchart of NW behavior when relative value approach is used (e.g., as described herein).

In some embodiments, before model inference, the NW performs one or more of operations 302-312. Before model inference, NW configures UE for resource measurement (e.g., what to measure) and optionally, indicates measurement approach to be used at UE. Alternatively, the measurement approach is defined in standard(s) and therefore is known to both the NW and the UE and thus is not required to be indicated. In some embodiments, the NW prepares itself through the steps shown inside the upper left box with dotted lines in FIG. 3:

At operation 302, a NW sends RRC configuration message(s) to UE, with the RRC configuration message(s) indicating resources to be measured/reported and optionally, the measurement approach to use.

At operation 304, a NW configures UE to report a model's (e.g., referred to as Model A hereafter for easy description) resource requirement in portion/percentage and occupation time, and the UE's total available resources, using one of the reporting mechanisms listed herein.

At operation 306, a NW receives UE reports on Model A's resource requirement in portion/percentage and occupation time.

At operation 308, NW may optionally receive UE reports on the traditional approach's (the traditional approach can be Model A's fallback target, which is a non-AI/ML approach) resource requirement in portion/percentage and occupation time. This information can be used to compare the resource requirements between an AI/ML model and a traditional approach (e.g. a non-AI/ML approach) that can achieve the same function. The information can be helpful when the NW needs to decide whether to switch/fallback to the traditional approach when the resource is not enough for running an AI/ML model/functionality. As an example, in a MIMO system, the UE needs to report estimated CSI to the network (which is called CSI feedback) after receiving the reference signal (RS) from the network. When the number of antennas is big (e.g., in the case of massive MIMO system), the CSI feedback overhead will become an issue. In current 3GPP standards, CSI feedback is compressed before being sent back to the network. However, this compression is prone to compression errors, degrading the performance of channel estimation. To improve the compression accuracy and efficiency, AI/ML-based approaches can be introduced. A common AI/ML-based approach is called autoencoder, with the encoder at the UE side and the decoder at the network side. In this example, the traditional approach means whatever CSI feedback compression methods used in current 3GPP standards (which are not AI/ML-based methods), while the AI/ML-based approach means whatever AI/ML models that can replace the traditional approaches, for example, the autoencoder model.

In some embodiments, when needed, at operation 310, a NW triggers UE to report on Model A's resource requirement, occupation time, and/or total available resource in portion/percentage.

In some embodiments, the steps above may be a one-time procedure for a specific model/model group at the NW.

In another embodiment, the steps before model inference at the NW may be in different orders from the order shown in FIG. 3.

At all times during which UE is operating, depending on the reporting mechanism used, at operation 312, a NW receives UE reports on total available resources in portion/percentage, reflecting the latest resource utilization at the UE (e.g., shown inside the lower left box with dotted lines). For example, the reporting can be done periodically by NW configuration.

Once the network controller or the NW determines to either deliver Model A to UE or activate Model A for inference at Model A, for example at operation 314, the NW can operate as below (e.g., shown inside the remaining operations in the right box with dotted lines).

At operation 316, a NW checks Model A's demand for resources as reported by the UE before the inference starts, and compares it to the latest available resource reported from the UE to determine whether there are enough resources at the UE to store Model A and/or to run Model A for inference. The determination of whether there are enough resources to store and/or run Model A at the UE is performed at operation 318.

If the answer is Yes, then at operation 320, the NW sends the request/configuration to store and/or run Model A at the UE. The NW then waits for the response from UE (e.g., at operation 322).

If the answer is No, then at operation 324, the NW checks to determine if there are any low-priority models can be deactivated/removed to release resources for Model A. Those low-priority models are also AI/ML models having lower priority than Model A.

If the answer is Yes, then at operation 326, the NW sends a request to deactivate one or more of the low-priority model(s), or to remove one or more low-priority model(s) to release resources for Model A. The NW then waits for the response from UE (e.g., at operation 322).

If the answer is No, then at operation 328, the NW continues to check if there is a traditional approach that can be used to achieve the same function as Model A. This step does not apply to storage space where the model needs to be stored, for example in case no low-priority models can be removed, the request for model transfer would fail.

If a traditional approach is found as the substitute of Model A and the UE can accommodate its resource requirements, at operation 330, the NW sends a request to the UE to run the traditional approach instead of Model A. The NW then waits for the response from UE (e.g., operation 322).

In some embodiments, if no traditional approach is found as the substitute of Model A, then at operation 332 both Model A and traditional approach fail to run. In some embodiments an error may be reported to the network controller. The process then ends in some such embodiments.

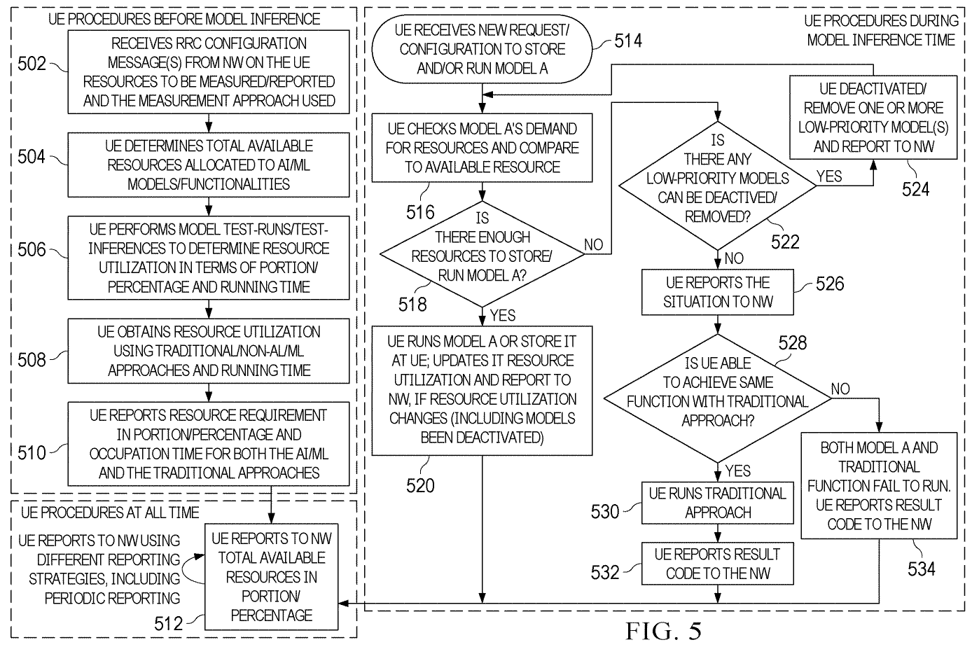

Although the UE side also performs the same examinations as the NW does in operation 318 in FIG. 3, operation 324 in FIG. 3, and operation 328 in FIG. 3 in FIG. 5, in some embodiments the main/important examinations are done at the NW. In some embodiments, the UE-side examination is meant to catch the exceptions when the NW-side examination/estimation is not accurate, likely due to the dynamic changes of resource utilization at the UE side. The advantage of NW-side checking is that overhead of model transfer or unnecessary model activation can be avoided without wasting channel resources and before informing the UE.

In another embodiment, the NW first checks whether it is able to achieve same functionality with traditional approach (e.g., at operation 328 in FIG. 3) before it checks to see if any low-priority models can be deactivated or removed from storage (e.g., at operation 324 in FIG. 3).

At operation 322, the NW waits for UE's response after sending to the UE one or more request(s). The handling of UE responses is described in FIG. 4, as Part 2 of the NW behavior. For example, FIG. 4 depicts a flowchart of NW behavior when relative value approach is used.

The flow begins at operation 416, upon a UE response being received. When a UE response is received by the NW, the following is performed in some embodiments:

The NW checks, at operation 418, whether it is the response for its request of storing/running Model A at UE.

If the answer to whether the response for its request of storing/running Model A at the UE is Yes, the NW, at operation 420, checks whether the request returns a success indication. If the answer to whether the request returns a success indication is Yes, and the request was on storage, then at operation 422 the NW transfers Model A to the UE, and/or records updated resource utilization of Model A. In the case the response is for computational power and/or memory, the response acts as a confirmation that model inference can be performed at the UE. The UE does not need to wait for the NW's further instruction to perform model inference. Therefore, when the UE response is received, the inference of Model A has been/is successfully being perform at the UE. In an alternative embodiment, the UE waits for the NW's further instruction/message to perform model inference. The NW also updates, at operation 422, the latest total available resources the UE sent over. If the answer to whether the request returns a success indication is No, the request for storing Model A and/or running Model A at UE would fail. The NW, at operation 436, may report failure and reason(s) to the network controller and records the updated resource utilization of Model A and the latest total available UE resources, if provided in the response. The NW then transits to normal operation as described in operation 312 in FIG. 3 and FIG. 4.

If the answer to whether the response for its request of storing/running Model A at the UE is No, the NW at operation 424 further checks whether the response is for the request of deactivating/falling back/removing one or more low-priority model(s) to release resources for Model A.

If the answer to whether the response is for the request of deactivating/falling back/removing one or more low-priority model(s) to release resources for Model A is Yes, the NW at operation 426 checks whether the request returns a success indication. If the answer to whether the request returns a success indication is Yes, the NW at operation 428 goes back to operation 316 in FIG. 3 to re-check whether there are enough resources to store/run Model A at UE after some resources have been released. The NW then continues operations from there. If the answer to whether the request returns a success indication is No, the request to deactivate/fall back/remove one or more low-priority model(s) at UE would fail. The NW, at operation 436, may report failure and reason(s) to the network controller and records the updated resource utilization of Model A and the latest total available UE resources, if provided in the response. The NW then transit to normal operation as described in operation 312 in FIG. 3 and FIG. 4.

If the answer to whether the response is for the request of deactivating/falling back/removing one or more low-priority model(s) to release resources for Model A is No, the NW at operation 430 further checks whether the response is for the request of running the traditional approach to achieve the same function of Model A. If the answer to whether the response is for the request of running the traditional approach to achieve the same function of Model A is Yes, the NW at operation 432 checks whether the request returns a success indication.

If the answer to whether the request returns a success indication is Yes, the NW at operation 434 records the result of the request (e.g., there are not enough resources to store/run the model so a same-function traditional approach is performed) and the latest total available UE resources.

If the answer to whether the request returns a success indication is No, the request to run the traditional approach to achieve the same function of Model A at UE would fail. The NW, at operation 436, may report failure and reason(s) to the network controller and records the updated resource utilization of Model A and the latest total available UE resources, if provided in the response. The NW then transits to normal operation as described in operation 312 in FIG. 3 and FIG. 4.

If the answer to whether the request returns a success indication is No, an exception would occur (a response cannot find its corresponding request). The NW at operation 438 handles the exception, then transits to normal operation as described in operation 312 in FIG. 3 and FIG. 4.

### Flowchart of UE Behavior

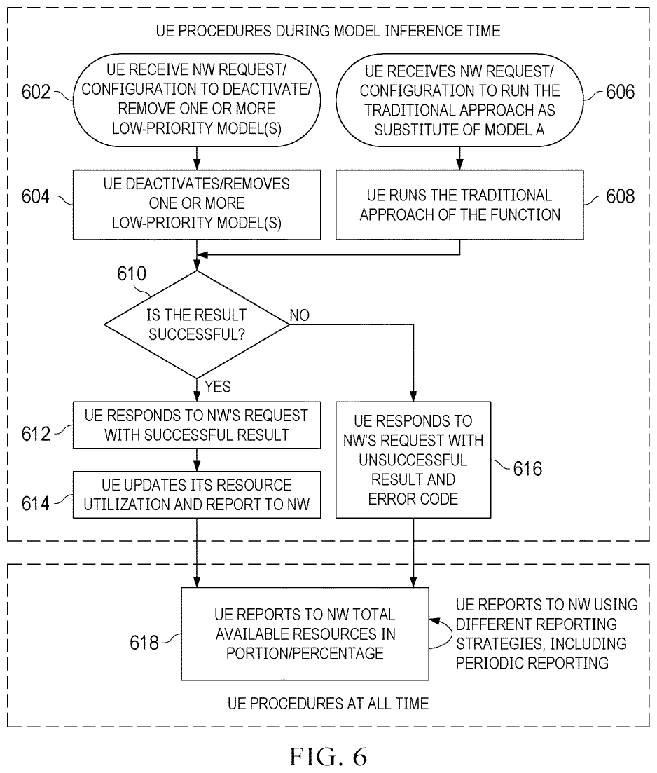

UE behavior is separated into three groups, behavior before model inference, behavior during model inference, and behavior the UE may be doing at all times, as shown in FIG. 5 and FIG. 6. For example, FIG. 5 depicts a flowchart of UE behavior when relative value approach is used. FIG. 6 depicts a flowchart of UE behavior when relative value approach is used.

Before model inference, in some embodiments a UE prepares itself for model inference by doing the following operations 502-510 (shown inside the upper left box with dotted lines of FIG. 5).

UE receives, at operation 502, RRC configuration message(s) from NW on the UE resources to be measured/reported and optionally, the measurement approach.

UE determines, at operation 504, total available resources allocated to AI/ML models/functionalities, depending on the measurement approach the UE uses. For example, reserved relevant resource to AI/ML models/functionalities.

UE performs, at operation 506, test-runs/test-inferences model to determine its resource utilization in terms of portion/percentage and running time. This is typically done by the vendor at the model development stage or by the carriers before putting the model to commission in real networks. Models are usually tested in different UE platforms to measure their resource requirements.

In order to compare the resource requirements between an AI/ML model and a traditional approach (e.g. non-AI/ML approach) that can achieve the same function, the UE may also, at operation 508, obtain the resource requirement using traditional approach(es) (e.g. non-AI/ML approach(es)) and running time. This information is helpful when the NW or UE decides whether to switch/fallback to the traditional approach when the resource is not enough for running an AI/ML model/function.

Once above measurements are completed, UE, at operation 510, reports resource requirement in portion/percentage and occupation time for the AI/ML approach and optionally, for the traditional approach.

The above steps may be a one-time procedure for a specific model/model group at the UE.

In another embodiment, the steps before model inference at the UE may be in different orders from the order shown in FIG. 5.

At all times during which UE is operating (e.g., shown inside the lower left box with dotted lines), depending on the reporting mechanism used, UE, at operation 512, reports to NW total available resources in portion/percentage, reflecting the latest resource utilization at the UE. For example, the reporting can be done periodically as a result of NW configuration.

Once a model is commissioned (e.g., ready to perform inference), a UE behaves as described below with respect to operations 514-534 (e.g., shown inside the right box with dotted lines), depending on the type of request is received.

In a first scenario, the UE receives a NW request/configuration to store and/or run Model A. An example of the flowchart is shown in FIG. 5.

In some embodiments, the flowchart starts with the UE, at operation 514, receiving a model transferred request from the NW, or upon the NW's request/configuration to run an AI/ML model, e.g., Model A, at the UE. The request was sent in accordance with operation 320 in FIG. 3.

Upon reception, the UE at operation 516 checks Model A's requirement for storage, or the resources it takes to perform model inference, and compare them to available resources, to determine, at operation 518, if there is enough storage space store Model A, or enough resources to run Model A.

If there is enough storage space to store Model A, or enough resources to run Model A, then the UE, at operation 520, (1) stores the Model A at UE or uses Model A to perform inference, (2) updates Model A's resource utilization status as a result of storing Model A and/or using Model A to perform inference, and (3) report to NW, if resource utilization changes. In some embodiments, the report may also include models been deactivated or removed from the UE in order to make room for Model A to run and/or to be stored (e.g., this information comes out from operation 522, when it is possible to deactivate/remove one or more low-priority models to make room for Model A).

If there is not enough storage space to store Model A, or not enough resources to run Model A, then the UE at operation 522, based on predefined priority order, checks to see if any low-priority models can be removed to release storage space to Model A, or be deactivated/fallback to traditional approach(es), to release resources for Model A to run.

If the answer to whether any low-priority models can be removed to release storage space to Model A, or be deactivated/fallback to traditional approach(es), to release resources for Model A to run is Yes, then the UE at operation 524 removes one or more low-priority model(s) from its storage, or deactivates one or more low-priority model(s) and optionally falls back to traditional approach(es) (if that saves resource occupation), and report this action to the NW. The UE then goes back to operation 516.

If no low-priority models can be removed to release storage space to Model A or can be deactivated or it cannot fall back to traditional approach(es) to release resources for Model A to run, the UE at operation 526 reports the situation to NW. In the case of model transfer request received from the NW, the model transfer would fail. The report at operation 526 could include the result code of model storage request, indicating that there is no enough space to store it at the UE. In the case of model inference, the UE at operation 528 further checks to see if the UE is able to achieve the same function with any traditional approach(es).

If the answer to whether the UE is able to achieve the same function with any traditional approach(es) is Yes, the UE at operation 530 runs traditional approach(es) and, at operation 532, reports the situation to the NW. The report indicates the traditional approach(es) used to replace Model A. The UE then goes back to operation 512 block for regular available resource reporting. If the UE is not able to achieve the same function with any traditional approach(es), either because the corresponding traditional approach(es) does/do not exist, or its/their requirement(s) for the amount of resources that has exceeded the amount the UE can accommodate, a failure would occur. The UE at operation 534 reports the situation and goes back to operation 512 for regular available resource reporting.

In another embodiment, the UE first checks whether it is able to achieve same function with traditional approach at operation 528 before it checks to see if any low-priority models can be deactivated or removed from storage at operation 522.

In another scenario, a UE receives NW request/configuration to deactivate/remove one or more low-priority model(s). An example flowchart is shown in FIG. 6.

In some embodiments, the flowchart starts with the UE, at operation 602, receiving a NW request/configuration to deactivate/remove one or more low-priority model(s). The request was sent in accordance with operation 326.

The UE at operation 604 deactivates/removes one or more low-priority model(s). In some embodiments, the UE executes NW order without making its own judgement whether to deactivate or remove a model.

The UE, at operation 610, checks whether the result is successful for the action. If the answer to whether the result is successful for the action is Yes, the UE, at operation 612, sends back to the NW a response for its request, indicating the successful result. The UE then, at operation 614, updates its resource utilization and reports it to NW. In some embodiments, after the release of occupied resources, the NW may re-check to determine if an AI/ML model inference can be performed at the UE, or a model can be transferred to the UE.

If the answer to whether the result is successful for the action is No, the UE at operation 616 responds to NW's request with unsuccessful result and error code.

In both successful and unsuccessful cases, the UE at operation 618 goes to regular reporting mode, in which the UE reports to NW total available resources in portion/percentage.

In a third scenario, the UE receives NW request/configuration to run the traditional approach as a substitute of Model A. An example of the flowchart is shown in FIG. 6 as an alternative and/or additional path. In some embodiments, the flowchart starts at operation 606 with the UE receiving a NW request/configuration to perform the traditional (e.g. non-AI/ML) approach as substitute of Model A. The request was sent in accordance with operation 330.

The UE at operation 608 performs the traditional (e.g. non-AI/ML) approach of the function. In some embodiments, the UE executes NW order without making its own judgement on whether to fall back to the traditional approach.

The UE at operation 610 checks whether the result is successful for the action. If the answer to whether the result is successful for the action is Yes, the UE at operation 612 sends back to the NW a response for its request, indicating the successful result. The UE at operation 614 then updates its resource utilization and reports it to NW. In some embodiments, after the release of occupied resources, the NW may re-check to determine if an AI/ML model inference can be performed at the UE, or a model can be transferred to the UE.

If the answer to whether the result is successful for the action is No, the UE at operation 616 responds to NW's request with unsuccessful result and error code.

In both successful and unsuccessful cases, the UE at operation 618 goes to regular reporting mode, in which the UE reports to NW total available resources in portion/percentage.

### Flowchart of NW-UE Communications

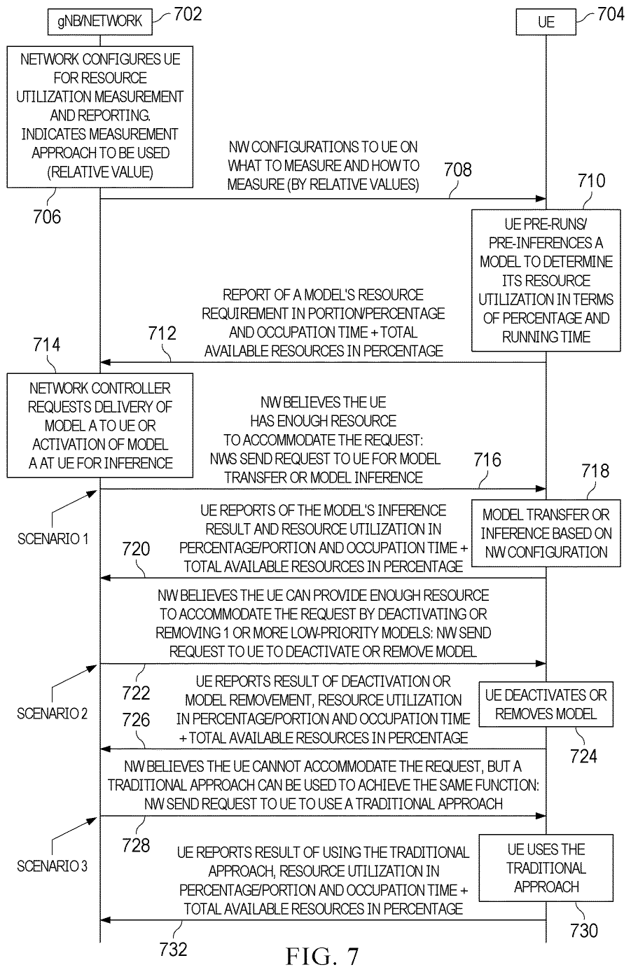

The NW communicates with each UE to exchange configuration information, NW-side requests, and reports of measurement results. The flowchart of NW-UE communications shows major message exchanges for UE capability/capacity reporting. The flowchart is shown in FIG. 7, for example depicting a flowchart of NW-UE communications. As depicted, FIG. 7 shows communications between a gNB/Network 702 and a UE 704. At operation 706, the network configures UE for resource utilization measurement and reporting, and indicates a measurement approach to be used. For example, a relative value approach may be used.

At operation 708, the NW configurations are sent to UE on what to measure and how to measure. For example, the indications may configure the UE to measure by relative value.

At operation 710, the UE pre-runs/pre-inferences a model to determine its resource utilization in terms of percentage and running time.

At operation 712, the UE reports a model's resource requirement in portion/percentage. Optionally in some embodiments the UE reports a resource occupation time (or a resource occupation timeline), and/or optionally a total available resources in percentage.

At operation 714, the network controller requests delivery of model A to UE or activation of Model A at UE for inference.

One of many scenarios may occur alternatively or additionally to one another. In some embodiments in a first scenario, at operation 716, the NW believes the UE has enough resources to accommodate the request, and the NWs send request to the UE for model transfer or model inference.

At operation 718, the model transfer or inference occurs at the UE 704 based on NW configuration.

At operation 720, the UE reports of the model's inference result and resource utilization in percentage/portion. Additionally or alternatively, optionally in some embodiments, the UE reports a resource occupation time (and/or resource occupation timeline), and/or optionally a total available resources in percentage.

In some embodiments in a second scenario, at operation 722 the NW believes the UE can provide enough resources to accommodate the request by deactivating or removing one or more low-priority models. In some embodiments, the NW sends a request to the UE to deactivate or remove a model.

At operation 724, the UE deactivates or removes the model.

At operation 726, the UE reports a result of deactivation or model removing, for example a resource utilization in percentage/portion. Optionally, in some embodiments, a resource occupation time and/or a total available resources may additionally be reported in absolute values.

In some embodiments, in a third scenario, at operation 728 the NW believes the UE cannot accommodate the request, but a traditional approach can be used to achieve the same function. In some embodiments, the NW sends a request to the UE indicating to use a traditional approach.

At operation 730, the UE uses the traditional approach.

At operation 732, the UE reports results of using the traditional approach, for example resource utilization in percentage/portion. Additionally or alternatively, in some embodiments, optionally the UE reports a resource occupation time (and/or resource occupation timeline), and/or optionally reports a total available resource amount in percentage.

The three scenarios shown in FIG. 7 may happen in different sequence in time.

### Measurement and Report by Absolute Values

In this approach, the absolute value of certain resource it takes for each model/functionality to run (e.g., inference) is measured. In some embodiments, the absolute value is used for at least one of computational power, memory, storage capacity, or other resources as described herein.

### Measurement and Report of Computational Power

In this approach the computational power is measured in terms of the number of floating-point operations per second (FLOPs) that can be performed. FLOPs is a measure of the number of floating-point arithmetic operations that a computing device can perform per second.

The following describes the procedures for the measurement and report of computational power, using the absolute value approach.

The NW sends RRC configuration message(s) to UE indicating the UE resources (for example, in this case, the computational power) need to be measured/reported and optionally, the measurement approach to use (in this case, measurement by absolute values).

Each model/model group is run/inferenced at a UE to determine its computational power requirement by the absolute value, for example, in FLOPs. The UE reports this measurement in absolute value, for example FLOPs, to the NW.

The UE also reports the available computing power to the NW, which is calculated by the following equation:

The available computing power=Nominal computing power*C₀*(1−Percentage of computing power being used), where the C₀ is the coefficient factor to adjust the nominal/peak computing capability. Setting C₀ to a number smaller than 1 provides cushion of the available computing power.

To smooth out random fluctuation, processing, such as simple/exponential moving average, can be used to represent the percentage of computing power that is being used.

The NW controls, based on a model's requirement of computing power, whether the model can be inferenced at the UE. This assumes the model's requirement of computing power in FLOPs is known at the NW. This may require prior test of the model on the UE's hardware platform.

### Measurement and Report of Memory

The following describes the procedures for the measurement and report of memory, using the absolute value approach:

The NW sends RRC configuration message(s) to UE indicating the UE resources (for example, in this case, the memory) need to be measured/reported and optionally, the measurement approach to use (in this case, measurement by absolute values).

Each model/model group is run/inferenced at a UE to determine its memory occupation by the absolute value, for example, in MBs.

This measurement in MBs is recorded and reported to the network.

The available memory in MBs is also reported to the network.

The NW determines/controls, based on a model's requirement of memory (e.g., in MBs), whether the model can be inferenced at the UE.

The network estimates/controls the number of models to run in the UE to make sure the total memory usage will not exceed the total available memory (e.g., in MBs) allocated to AI/ML tasks for wireless communications.

### Measurement and Report of Storage Capacity

The following describes the general procedures for the measurement and report of storage capacity, using the absolute value approach. Detailed steps of the embodiment and the flowchart are provided below.

The NW sends RRC configuration message(s) to UE indicating the UE resources (for example, in this case, the storage) need to be measured/reported and optionally, the measurement approach to use (for example, in this case, measurement by absolute values).

Each model/model group is downloaded/delivered to the UE to determine its actual storage requirements. As an alternative, in some embodiments, the model size information can be made to the UE via other means, such as offline provisioning or message from the network-side.

The exact measurement (in MBs) of the storage space it takes to store the model/model group is recorded and reported to the network, using one of the reporting mechanisms provided herein.

The available storage space (in MBs) is also reported to the network, using one of the reporting mechanisms provided herein.

The network receives and records the size of the model/functionality in the storage, as well as the total size of storage available.

The NW determines/controls, based on a model's requirement of storage space and the situation of overall storage space, whether a model can be transferred and stored at the UE. The NW transfers/delivers the model to the UE if it determines that there is enough storage space at the UE.

In some embodiments, if the total storage space is not enough for storing the model, the NW decides what model/model group to be removed from the UE, for example if possible. Once decided, the NW communicates to the UE to indicate the model/model group to be removed.

### The Flowchart of the Absolute Value Approach

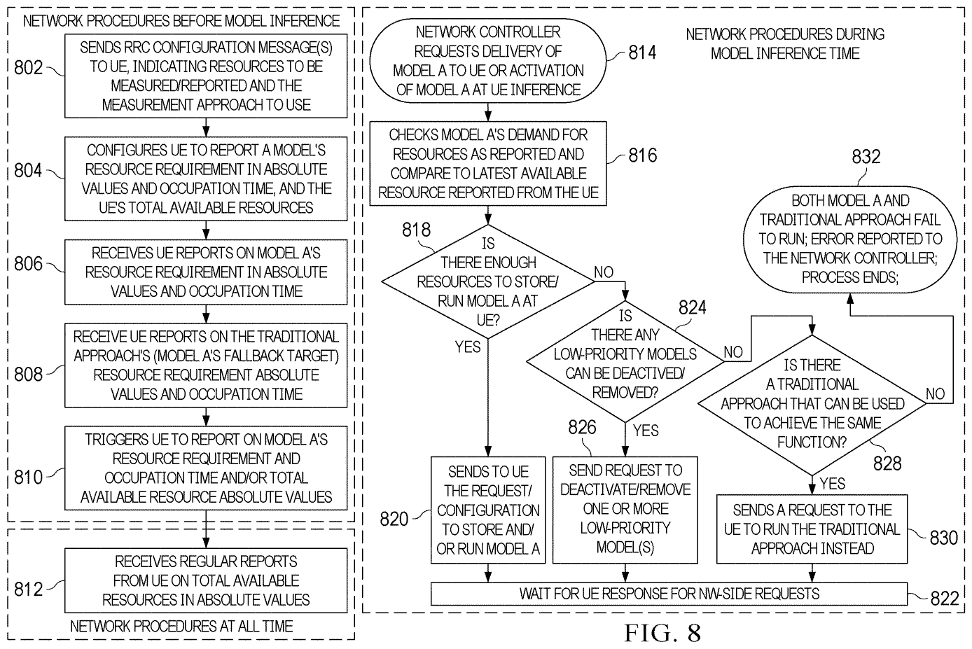

Further herein, flowcharts are provided for illustrating NW behavior, UE behavior and the communications between NW and UE. The flowchart of NW behavior is separated in two figures, FIG. 8 and FIG. 9. FIG. 8 depicts a flowchart of NW behavior when absolute value approach is used (e.g., as described herein).

Before model inference, NW configures UE for resource measurement (e.g., what to measure) and optionally, indicates measurement approach to be used at UE. The NW prepares itself through the steps shown inside the upper left box with dotted lines in FIG. 8.

At operation 802, the NW sends RRC configuration message(s) to UE, indicating resources to be measured/reported and optionally, the measurement approach to use.

At operation 804, the NW configures UE to report a model's resource requirement in absolute values and occupation time, and the UE's total available resources, using one of the reporting mechanisms listed in herein.

At operation 806, the NW receives UE reports on Model A's resource requirement in absolute values and occupation time.

At operation 808, the NW receives UE reports on the traditional approach's (the traditional approach is Model A's fallback target which is a non-AI/ML approach) resource requirement in absolute values and occupation time. This information can be used to compare the resource requirements between an AI/ML model and a traditional approach (i.e., non-AI/ML approach) that can achieve the same function. The information can be helpful when the NW needs to decide whether to switch/fallback to the traditional approach when the resource is not enough for running an AI/ML model/functionality.

In some embodiments, when needed, at operation 810 the NW triggers UE to report on Model A's resource requirement, occupation time, and/or total available resource in absolute values.

In some embodiments, the steps above may be a one-time procedure for a specific model/model group at the NW.

In another embodiment, the steps before model inference at the NW may be in different orders from the order shown in FIG. 8.

At all times during which UE is operating, depending on the reporting mechanism used, the NW at operation 812 receives UE reports on total available resources in absolute values, reflecting the latest resource utilization at the UE (e.g., shown inside the lower left box with dotted lines). For example, the reporting can be done periodically by NW configuration.

Once a request is received from the network controller of the NW to either deliver Model A to UE or activate Model A for inference at Model A, for example at operation 814, the NW behaves as below (e.g., shown inside the right box with dotted lines).

At operation 816, the NW checks Model A's demand for resources as reported by the UE before the inference starts, and compares it to the latest available resource reported from the UE to determine, at operation 818, whether there are enough resources at the UE to store Model A or to run Model A for inference.

If the answer to whether there are enough resources at the UE to store Model A and/or to run Model A for inference is Yes, then the NW, at operation 820, sends the request/configuration to store and/or run Model A at the UE. The NW at operation 822 then wait for the response from UE.

If the answer to whether there are enough resources at the UE to store Model A or to run Model A for inference is No, then the NW at operation 824 checks to determine if any low-priority models can be deactivated removed to release resources for Model A.

If the answer to if any low-priority models can be deactivated removed to release resources for Model A is Yes, then the NW at operation 826 send a request to deactivate one or more of the low-priority model(s), or to remove one or more low-priority model(s) to release resources for Model A. The NW at operation 822 then wait for the response from UE.

If the answer if any low-priority models can be deactivated removed to release resources for Model A is No, then the NW at operation 828 continue to check if there is a traditional approach that can be used to achieve the same function as Model A. In some embodiments this step does not apply to storage space where the model needs to be stored; in case no low-priority models can be removed, the request for model transfer would fail.

In some embodiments, if a traditional approach is found as the substitute of Model A and the UE can accommodate its resource requirement, the NW at operation 830 sends a request to the UE to run the traditional approach instead of Model A. The NW at operation 822 then wait for the response from UE.

In some embodiments, if no traditional approach is found as the substitute of Model A, then both Model A and traditional approach fail to run. NW at operation 832 may report this error to the network controller. The process ends.

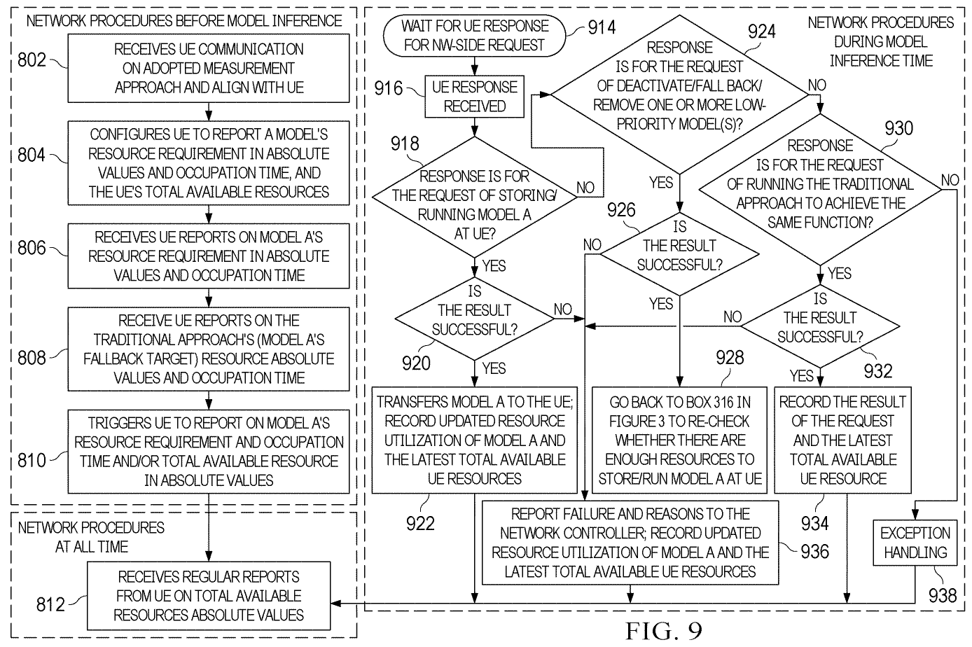

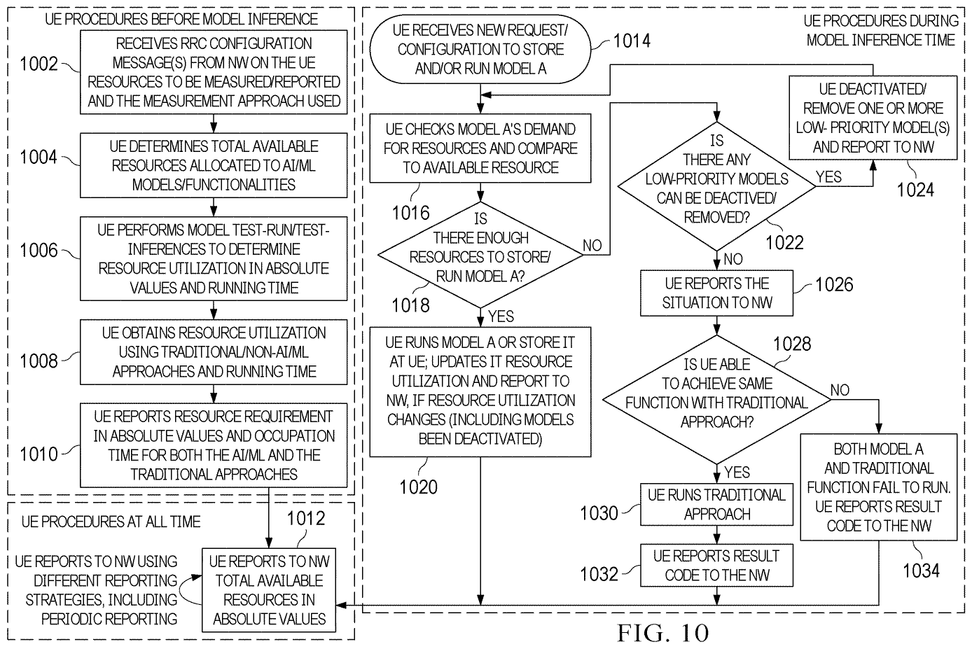

In some embodiments, although the UE side also does the same examinations as the NW does in operation 1018, operation 1022, and operation 1028 in FIG. 10, primary examinations are done at the NW. In some such embodiments, the UE-side examination is meant to catch the exceptions when the NW-side examination/estimation are not accurate, likely due to the dynamic changes of resource utilization at the UE side. An advantage of NW-side checking is that overheads of model transfer or unnecessary model activation can be avoided right at the NW without going through the wireless channel to the UE.

In another embodiment, the NW first checks whether it is able to achieve same function with traditional approach at operation 828 before it checks to see if any low-priority models can be deactivated or removed from storage at operation 824.

The NW at operation 822 waits for UE's response after sending to the UE one or more request(s). The handling of UE responses is described in FIG. 9, as Part 2 of the NW behavior. For example, FIG. 9 depicts a flowchart of NW behavior when absolute value approach is used.

When a UE response is received by the NW at operation 916, for example after waiting for the UE response for NW-side request at operation 914, the following is performed in some embodiments.

The NW at operation 918 checks to see whether it is the response to its request of storing/running Model A at UE (e.g., the request at operation 820 in FIG. 8).

If the answer to whether it is the response to its request of storing/running Model A at UE is Yes, the NW at operation 920 checks whether the request returns a success indication.

If the answer to whether the request returns a success indication is Yes, and the request was on storage, then the NW at operation 922 transfers Model A to the UE, and/or records updated resource utilization of Model A. In the case the response is for computational power and/or memory, the response acts as a confirmation that model inference can be performed at the UE. The UE does not need to wait for the NW's further instruction to perform model inference. Therefore, when the UE response is received, the inference of Model A has been/is successfully being perform at the UE. In an alternative embodiment, the UE waits for the NW's further instruction/message to perform model inference. In some embodiments, the NW also updates the latest total available resources the UE sent over.

If the answer to whether the request returns a success indication is No, the request for storing Model A or running Model A at UE would fail. The NW at operation 936 reports failure and reason(s) to the network controller and records the updated resource utilization of Model A and the latest total available UE resources, if provided in the response. The NW then transit to normal operation as described in operation 812.

If the answer to whether it is the response to its request of storing/running Model A at UE is No, the NW at operation 930 further checks whether the response is for the request of deactivating/falling back/removing one or more low-priority model(s) to release resources for Model A.

If the answer to whether it is the response to its request of storing/running Model A is Yes, the NW at operation 926 checks whether the request returns a success indication. If the answer to whether the request returns a success indication is Yes, the NW at operation 928 goes back to operation 816 in FIG. 8 to re-check whether there are enough resources to store/run Model A at UE after some resources have been released. The NW then continues operations from there. If the answer to whether the request returns a success indication is No, the request to deactivate/fall back/remove one or more low-priority model(s) at UE would fail. The NW at operation 936 reports failure and reason(s) to the network controller and records the updated resource utilization of Model A and the latest total available UE resources, if provided in the response. The NW then transit to normal operation as described in operation 812.

If the answer to whether it is the response to its request of storing/running Model A is No, the NW at operation 930 further checks whether the response is for the request of running the traditional approach to achieve the same function of Model A.

If the answer to whether the response is for the request of running the traditional approach to achieve the same function of Model A is Yes, the NW at operation 932 checks whether the request returns a success indication. If the answer to whether the request returns a success indication is Yes, the NW at operation 934 records the result of the request (i.e., there was no enough resources to store/run the model so a same-function traditional approach is performed) and the latest total available UE resources. If the answer to whether the request returns a success indication is No, the request to run the traditional approach to achieve the same function of Model A at UE would fail. The NW at operation 936 reports failure and reason(s) to the network controller and records the updated resource utilization of Model A and the latest total available UE resources, if provided in the response. The NW then transit to normal operation as described in operation 812.

If the answer to whether the response is for the request of running the traditional approach to achieve the same function of Model A is No, an exception would occur (a response cannot find its corresponding request). The NW at operation 938 handles the exception, then transits to normal operation as described in operation 812.

### Flowchart of UE Behavior

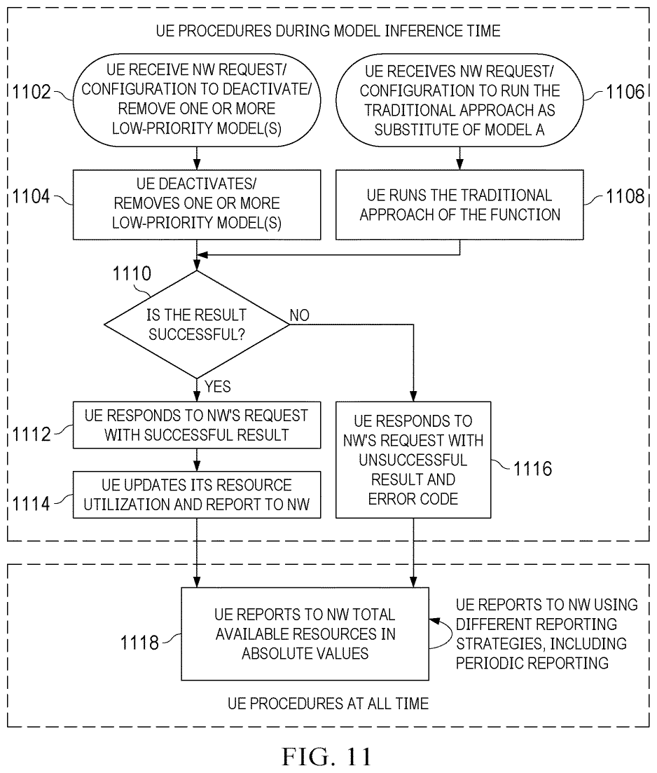

UE behavior is separated into three groups, behavior before model inference, behavior during model inference, and behavior the UE may be doing at all times, as shown in FIG. 10 and FIG. 11. For example, FIG. 10 depicts a flowchart of UE behavior when absolute value approach is used. Additionally, for example, FIG. 11 depicts a flowchart of further UE behavior when absolute value approach is used.

In some embodiments, before model inference, the UE prepares itself for model inference by doing the following (e.g., shown inside the upper left box with dotted lines of FIG. 10).

The UE at operation 1002 receives RRC configuration message(s) from NW on the UE resources to be measured/reported and optionally, the measurement approach.

The UE at operation 1004 determines total available resources allocated to AI/ML models/functionalities, depending on the measurement approach the UE uses. For example, reserved relevant resource to AI/ML models/functionalities.

The UE at operation 1006 performs test-runs/test-inferences of the model to determine its resource utilization in terms of absolute values and running time. This is typically done by the vendor at the model development stage or by the carriers before putting the model to commission in real networks. Models are usually tested in different UE platforms to measure their resource requirements.

In order to compare the resource requirements between an AI/ML model and a traditional approach that can achieve the same function, the UE in some embodiments at operation 1008 also obtains the resource requirement using traditional approach(es) and running time. This information is helpful when the NW or UE decides whether to switch/fallback to the traditional approach when the resource is not enough for running an AI/ML model/function.

In some embodiments, once above measurements are completed, the UE at operation 1010 reports resource requirement in absolute values and occupation time for both the AI/ML approach and the traditional approach.

The steps above may be a one-time procedure for a specific model/model group at the UE.

In another embodiment, the steps before model inference at the UE may be in different orders from the order shown in FIG. 10.

At all times during which UE is operating (e.g., shown inside the lower left box with dotted lines), depending on the reporting mechanism used, the UE at operation 1012 reports to NW total available resources in absolute values, reflecting the latest resource utilization at the UE. For example, the reporting can be done periodically as a result of NW configuration.

Once a model is commissioned e.g., ready to perform inference), a UE behaves as below (e.g., shown inside the right box with dotted lines), Depending on what type of request is received.

In a first scenario, the UE receives a NW request/configuration to store and/or run Model A. An example of the flowchart is shown in FIG. 10.

In some embodiments, the flowchart starts with the UE at operation 1014 receiving a model transferred request from the NW, or upon the NW's request/configuration to run a model, e.g., Model A, at the UE. The request was sent in accordance with operation 820 in FIG. 8.

Upon reception, the UE at operation 1016 checks Model A's requirement for storage, or the resources it takes to perform model inference, and compare them to available resources, to determine at operation 1018 if there is enough storage space store Model A, or enough resources to run Model A.

If there is enough storage space to store Model A, or enough resources to run Model A, then the UE at operation 1020 (1) stores it at UE or uses Model A to perform inference, (2) updates Model A's resource utilization status as a result of storing Model A or using Model A to perform inference, and (3) report to NW, if resource utilization changes. In some embodiments, the report may also include models been deactivated or removed from the UE in order to make room for Model A to run or to be stored (e.g., this information comes out from operation 1022, when it is possible to deactivate/remove one or more low-priority models to make room for Model A).

If there is not enough storage space to store Model A, or not enough resources to run Model A, then the UE at operation 1022, based on predefined priority order, checks to see if any low-priority models can be removed to release storage space to Model A, or be deactivated/fallback to traditional approach(es) to release resources for Model A to run.

If the answer to if any low-priority models can be removed to release storage space to Model A, or be deactivated/fallback to traditional approach(es) to release resources for Model A to run is Yes, then the UE at operation 1024 removes one or more low-priority model(s) from its storage, or deactivates one or more low-priority model(s) and optionally falls back to traditional approach(es) (e.g., if that saves resource occupation), and report this action to the NW. The UE then goes back to operation 1016.

If no low-priority models can be removed to release storage space to Model A or can be deactivated or it cannot fall back to traditional approach(es) to release resources for Model A to run, the UE at operation 1026 reports the situation to NW. In the case of model transfer request received from the NW, the model transfer would fail. The report could include the result code of model storage request, indicating that there is not enough space to store it at the UE. In the case of model inference, the UE at operation 1028 further checks to see if the UE is able to achieve the same function with any traditional approach(es).

If the answer to if the UE is able to achieve the same function with any traditional approach(es) is Yes, the UE at operation 1030 runs traditional approach(es) and, at operation 1032, reports the situation to the NW. The report indicates the traditional approach(es) used to replace Model A. The UE then goes back to operation 1012 for regular available resource reporting.

If the UE is not able to achieve the same function with any traditional approach(es), either because the corresponding traditional approach(es) does/do not exist, or its/their requirement(s) for the amount of resources that has exceeded the amount the UE can accommodate, a failure would occur. The UE at operation 1034 reports the situation and goes back to operation 1012 for regular available resource reporting.

In another embodiment, the UE first checks whether it is able to achieve same function with traditional approach (e.g., operation 1028 in FIG. 10) before it checks to see if any low-priority models can be deactivated or removed from storage (e.g., operation 1022 in FIG. 10).

FIG. 11 depicts a flowchart associated with a second scenario of a UE receiving a NW request/configuration to deactivate/remote one or more low-priority model(s). An example flowchart is shown in FIG. 11.

In some embodiments, the flowchart starts with the UE at operation 1102 receiving a NW request/configuration to deactivate/remove one or more low-priority model(s). The request was sent in accordance with operation 826.

The UE at operation 1104 deactivates/removes one or more low-priority model(s). In some embodiments, the UE executes NW order without making its own judgement whether to deactivate or remove a model.

The UE at operation 1110 checks whether the result is successful for the action. If the answer whether the result is successful for the action is Yes, the UE at operation 1112 sends back to the NW a response for its request, indicating the successful result. The UE at operation 1114 then updates its resource utilization and reports it to the NW. In some embodiments, after the release of occupied resources, the NW at operation 1114 may re-check to determine if an AI/ML model inference can be performed at the UE, or a model can be transferred to the UE.

If the answer to whether the result is successful for the action is No, the UE at operation 1116 responds to NW's request with unsuccessful result and error code.

In both successful and unsuccessful cases, the UE goes to regular reporting mode, in which the UE at operation 1118 reports to NW total available resources in absolute values.

In a third scenario, the UE receives NW request/configuration to run the traditional approach as substitute of Model A. An example of the alternative path of the flowchart is shown in FIG. 11.

In some embodiments, the flowchart starts with the UE at operation 1106 receiving a NW request/configuration to perform the traditional/non-AI/ML approach as substitute of Model A. The request was sent in accordance with operation 830 in FIG. 8.

The UE at operation 1108 performs the traditional/non-AI/ML approach of the function. In some embodiments, the UE executes NW order without making its own judgement on whether to fall back to the traditional/non-AI/ML approach. The UE at operation 1110 checks whether the result is successful for the action.

If the answer to whether the result is successful for the action is Yes, the UE at operation 1112 sends back to the NW a response to its request, indicating the successful result. The UE at operation 1114 then updates its resource utilization and reports it to the NW. In some embodiments, after this release of occupied resources, the NW may re-check to determine if an AI/ML model inference can be performed at the UE, or a model can be transferred to the UE.

If the answer to whether the result is successful for the action is No, the UE at operation 1116 responds to NW's request with unsuccessful result and error code.

In both successful and unsuccessful cases, the UE at operation 1118 goes to regular reporting mode, in which the UE reports to NW total available resources in absolute values.

### Flowchart of NW-UE Communications

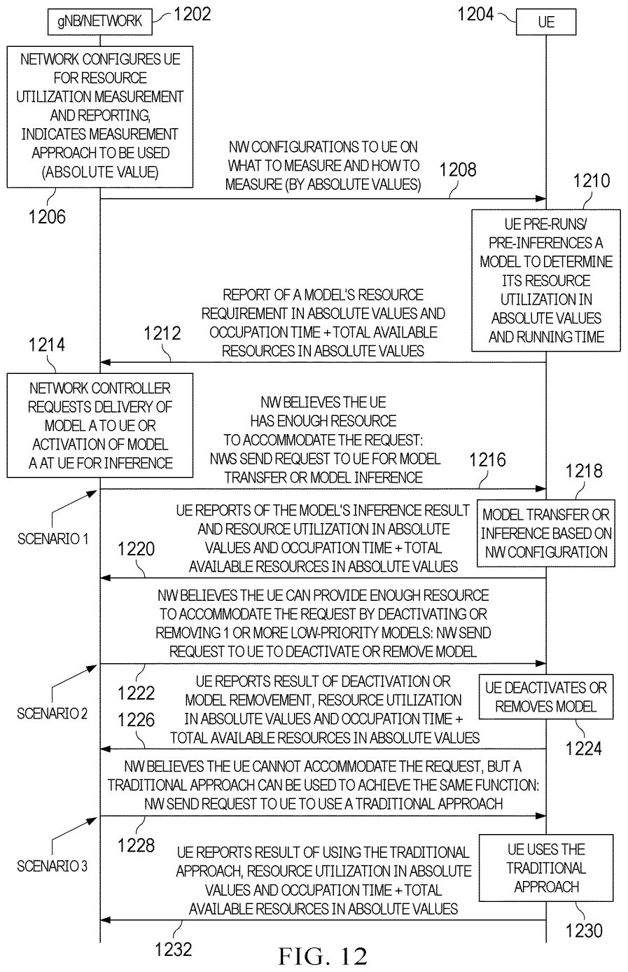

The NW communicates with each UE to exchange configuration information, NW-side requests, and reports of measurement results. The flowchart of NW-UE communications shows major message exchanges for UE capability/capacity reporting. The flowchart is shown in FIG. 12, for example depicting a flowchart of NW-UE communications.

As depicted, FIG. 11 shows communications between a gNB/Network 1202 and a UE 1204. At operation 1206, the network configures UE for resource utilization measurement and reporting, and indicates a measurement approach to be used. For example, an absolute value approach may be used.

At operation 1208, the NW configurations are sent to UE on what to measure and how to measure by absolute values.

At operation 1210, the UE pre-runs/pre-inferences a model to determine its resource utilization in absolute values and running time.

At operation 1212, the UE reports a model's resource in absolute values. Optionally in some embodiments the UE reports a resource occupation time (or a resource occupation timeline), and/or optionally a total available resources in absolute values.

At operation 1214, the network controller requests delivery of Model A to UE or activation of Model A at UE for inference.

One of many scenarios may occur alternatively or additionally to one another. In some embodiments in a first scenario, at operation 1216, the NW believes the UE has enough resource to accommodate the request, and the NWs send request to the UE for model transfer or model inference.

At operation 1218, the model transfer or inference occurs at the UE 1204 based on NW configuration.

At operation 1220, the UE reports of the model's inference result and resource utilization in absolute values. Additionally or alternatively, optionally in some embodiments, the UE reports a resource occupation time (and/or resource occupation timeline), and/or optionally a total available resources in absolute values.

In some embodiments in a second scenario, at operation 1222 the NW believes the UE can provide enough resources to accommodate the request by deactivating or removing one or more low-priority models. In some embodiments, the NW sends a request to the UE to deactivate or remove a model.

At operation 1224, the UE deactivates or removes the model.

At operation 1226, the UE reports a result of deactivation or model removing, for example a resource utilization in absolute values. Optionally, in some embodiments, a resource occupation time and/or a total available resources may additionally be reported in absolute values.

In some embodiments, in a third scenario, at operation 1228 the NW believes the UE cannot accommodate the request, but a traditional approach can be used to achieve the same function. In some embodiments, the NW sends a request to the UE indicating to use a traditional approach.

At operation 1230, the UE uses the traditional approach.

At operation 1232, the UE reports results of using the traditional approach, for example resource utilization in absolute values. Additionally or alternatively, in some embodiments, optionally the UE reports a resource occupation time (and/or resource occupation timeline), and/or optionally reports a total available resource amount in absolute values.

The three scenarios shown in FIG. 12 may happen in different sequence in time.

### Measurement and Report by a Reference Processing Power

In this approach, a number of MPUs of certain resource it takes for each model/functionality to run (e.g., inference) is measured. In some embodiments, the MPUs is used for at least one of computational power, memory, storage capacity, or other resources as described herein.

### Machine-Learning Processing Unit (MPU)

In this embodiment, a Machine-Learning Processing Unit (MPU) is defined as the computational power (and memory) required/consumed to perform a basic AI/ML model/task. Note the way a basic AI/ML model/task is defined is outside the scope of this disclosure.

The MPU is used to measure the UE's capability for performing AI/ML model inference, as well as the demand of computational power (and memory) of each model, measured at the number of MPUs (N_{MPU}). For example, a UE may handle 100 MPUs simultaneously. Continuing this example, a model may need 5 MPUs to inference.

Various considerations for MPU definition are addressed. In some embodiments, the MPU should be defined in a way that allows it to be used across different UE hardware platforms and understood by both the NW and the UEs in the same way. The granularity of MPU (for example, which is related to the computational complexity (and memory) of the basic AI/ML model/task) can be decided based on different strategical preference. For example, a finer and tighter granularity provides more precise measurement but may lead to less tolerance of measurement errors. Alternatively, a coarser granularity provides more cushion for measurement errors, including measurements under uncommon situations such as overloaded and underloaded scenarios, but may lead to over-provision of the UE's processing power (e.g., a waste of computational power and memory).

In current 3GPP UE capability report mechanism, for a specific functionality or UE feature group, the UE reports whether it supports the feature group along with some relevant parameters often indicating the amount or level of support, for example, N_{cpu} (here CPU=CSI processing unit) as in the case of CSI. The network controller may configure the UE to perform such a functionality, and the UE will ensure resources are available to carry out the functionality if the configuration is within those relevant parameters reported. Therefore, the consequence is that the UE needs to have resources to potentially perform all functions it reports to support whenever the network controller configures. In the case of AI/ML-enabled functions, this may require a large amount of resources available at the UE, though it is unlikely all AI/ML-enabled functions are active at the same time.

The following describes procedures for the measurement and report of computational power (and memory), using the MPU. The NW sends RRC configuration message(s) to UE indicating the UE resources (for example, in this case, the computational power (and memory)) need to be measured/reported and optionally, the measurement approach to use (for example, in this case, measurement by the MPU). Alternatively, the measurement approach is defined in standard(s) and therefore is known to both the NW and the UE and thus is not required to be indicated.

Each model/model group may be run/inferenced at a UE to determine its requirement for computing power (and memory), in the number of MPUs needed, i.e., N_{MPU}. In some embodiments, the result is recorded/processed and reported to the network. Alternatively, the number of MPU required for an AI/ML or AI/ML-enabled function may be obtained at the network controller and indicated to the UE device.

Additionally, in some embodiments, the UE also reports the number of supported simultaneous M_{MPU} to the network. The NW controller determines, based on this information, whether a model can be run/inferenced at the UE and indicates to the UE concerning AI/ML models or AI/ML-enabled functions accordingly.

The MPU based reporting and utilization can be viewed as a variant of reporting by relative value where the total available/reserved resources are quantified as M_{MPU} resource units and an AI/ML model or AI/ML-enabled functionality requires N_{MPU} out of M_{MPU} resources. In some embodiments, because the MPU-based reporting and utilization can be viewed as a variant of reporting by relative values, the NW behavior, UE behavior and the communications between NW and UE are similar to that of the relative value approach. The flowcharts discussed herein for relative value approach may be referred to for the MPU approach. With appropriate modifications, the UE reporting mechanism can also be used to report other capabilities/capacities to the network, such as battery level of a UE and/or another measurable resource.

### Resource Occupation Time/Timeline

In some embodiments, resource occupation time at the UE may be used as information for the NW to understand the UE's resource utilization. In some embodiments, a common understanding between the UE and the network controller is established either through specification definition, network configuration, or UE reporting.

In some embodiments, every time a model/model group is run/inferenced at the UE, the starting time and duration of its resource occupation may be recorded/processed, along with the utilization of various resources. In some embodiments, whenever a report is sent to the NW, the expected resource occupation duration is also sent to the NW. With the history of this information, the NW will be able to select appropriate models/model groups to run at the appropriate times in the future, if clear pattern of resource utilization can be derived from the information.

In some other embodiments, the resource occupation time/timeline is associated with a model/functionality because the corresponding feature(s) needs to be controlled (e.g., completed within required timeline). For example, CSI report should be sent within say T ms after the corresponding CSI-RS transmission. In this case, the timeline may be defined for the feature (for example reuse that of non-AI/ML-based scheme), the UE then reports the resource needed to meet the timeline. The timeline also determines the resource occupancy time. For some cases, the timeline may also depend on the reported UE capability (e.g., of a limited number of values). For example, UE may report that N_1 resource required for an AI/ML model or AI/ML-enabled function with one duration or timeline, and that N_2 resource required for the AI/ML model or AI/ML-enabled function with another different duration or timeline. When network controller indicates the UE to perform AI/ML model inference or AI/ML-enabled function, it also indicates the associated timeline.

The network controller tracks the total percentage/portion of the reserved resource(s) already used by AI/ML models or AI/ML-enabled functions for the concerned time instance(s) based on the reported required resource(s) and occupancy duration(s). The network controller then determines whether an AI/ML model or AI/ML-enabled function can be performed at the UE at certain time intervals based on its reported required resource(s) and occupancy duration(s) and indicates the UE device accordingly concerning AI/ML models or AI/ML-enabled functions.

### Model Inference Priorities

With the measurement and reporting mechanisms introduced so far, the UE's resource utilization should be well-controlled to be within the maximum available/allowed.

In the rare cases where the combined requirements from all the models/functionalities exceed the UE capabilities and capacities (e.g., at certain time instance or during a time interval), the UE may decide to deactivate some AI/ML models/functionalities and/or fallback to traditional methods (for example, if possible/available).

In some embodiments, to enable the operation, models/functionalities may be pre-classified into different priority levels/groups, for example, high-, mid-, and low-priority groups, or priority order is assigned to AI/ML models or AI/ML-enabled functionalities. The UE, when needed, deactivates some AI/ML models/functionalities and/or fallback to traditional methods (for example, if possible/available) starting from lower priority AI/ML model(s) or AI/ML-enabled function(s).

In some embodiments, while the definition and configuring/reporting of the priority levels are standard-related issues, the assignment of models/functionalities to specific categories of priorities may be an implementation issue.

In some embodiments, when the UE determines whether the combined requirements for computational power or memory or other type of resource from the functionalities exceed the allowed/reserved portion/percentage allocated at the UE, it may be according to the reported required resource for the AI/ML models or the AI/ML-enable functionalities. As long as the combined requirements for resource(s) from the functionalities does not exceed the allowed/reserved portion/percentage allocated at the UE, it is up to UE implementation to ensure resource(s) are available to perform these functionalities.

### Reporting Mechanisms

In some embodiments, UE reporting of required resource(s) for an AI/ML model or AI/ML-enabled functionality and the UE reporting of available resource(s) for AI/ML models or AI/ML-enabled functionalities can be configured in any one of various ways:

Periodic reporting: a report is sent periodically with certain (configured) periodicity and time offset.

Timer based reporting: a report is sent by the expiration of a pre-configured timer (by the network). The reports for different resources may require different timers.

Event-triggered reporting: a report is sent when the resources of concern are below/above pre-configured thresholds.

On-demand reporting: a report is sent upon receiving a message requesting the report from the network.

UE-initiated reporting: a report is sent when the UE has a measurement of resource for a new model/functionality. UE may do this only when a new model/functionality is introduced.

In some embodiments, the UE reporting is configured to adapt to the characteristics of resources of concern and the AI/ML models/functionalities using them. For example, some embodiments can configure different frequencies of reporting for different AI/ML models. As another example, some other embodiments can configure the computational power and memory to be reported more frequently than the storage capacity of the UE.

The UE report can be sent using L1 channel such as PUCCH, or MAC-CE, or RRC signaling.

### System Aspects

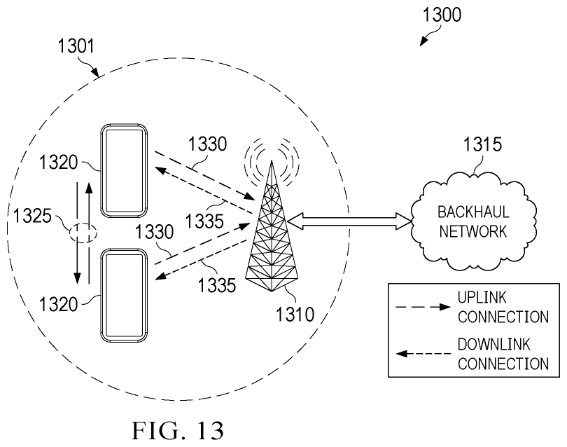

FIG. 13 illustrates an example communications system 1300. Communications system 1300 includes an access node 1310 serving user equipments (UEs) with coverage 1301, such as UEs 1320. In a first operating mode, communications to and from a UE passes through access node 1310 with a coverage area 1301. The access node 1310 is connected to a backhaul network 1315 for connecting to the internet, operations and management, and so forth. In a second operating mode, communications to and from a UE do not pass through access node 1310, however, access node 1310 typically allocates resources used by the UE to communicate when specific conditions are met. Communications between a pair of UEs 1320 can use a sidelink connection (shown as two separate one-way connections 1325). In FIG. 13, the sideline communication is occurring between two UEs operating inside of coverage area 1301. However, sidelink communications, in general, can occur when UEs 1320 are both outside coverage area 1301, both inside coverage area 1301, or one inside and the other outside coverage area 1301. Communication between a UE and access node pair occur over uni-directional communication links, where the communication links between the UE and the access node are referred to as uplinks 1330, and the communication links between the access node and UE is referred to as downlinks 1335.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, and the like. While it is understood that communications systems may employ multiple access nodes capable of communicating with a number of UEs, only one access node and two UEs are illustrated for simplicity.

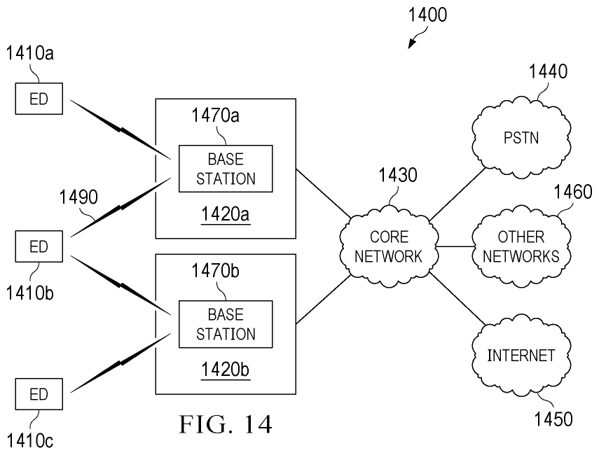

FIG. 14 illustrates an example communication system 1400. In general, the system 1400 enables multiple wireless or wired users to transmit and receive data and other content. The system 1400 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1400 includes electronic devices (ED) 1410a-1410c, radio access networks (RANs) 1420a-1420b, a core network 1430, a public switched telephone network (PSTN) 1440, the Internet 1450, and other networks 1460. While certain numbers of these components or elements are shown in FIG. 14, any number of these components or elements may be included in the system 1400.

The EDs 1410a-1410c are configured to operate or communicate in the system 1400. For example, the EDs 1410a-1410c are configured to transmit or receive via wireless or wired communication channels. Each ED 1410a-1410c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1420a-1420b here include base stations 1470a-1470b, respectively. Each base station 1470a-1470b is configured to wirelessly interface with one or more of the EDs 1410a-1410c to enable access to the core network 1430, the PSTN 1440, the Internet 1450, or the other networks 1460. For example, the base stations 1470a-1470b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1410a-1410c are configured to interface and communicate with the Internet 1450 and may access the core network 1430, the PSTN 1440, or the other networks 1460.

In the embodiment shown in FIG. 14, the base station 1470a forms part of the RAN 1420a, which may include other base stations, elements, or devices. Also, the base station 1470b forms part of the RAN 1420b, which may include other base stations, elements, or devices. Each base station 1470a-1470b operates to transmit or receive wireless signals within a particular geographic region or area, sometimes referred to as a “cell.” In some embodiments, multiple-input multiple-output (MIMO) technology may be employed having multiple transceivers for each cell.

The base stations 1470a-1470b communicate with one or more of the EDs 1410a-1410c over one or more air interfaces 1490 using wireless communication links. The air interfaces 1490 may utilize any suitable radio access technology.

It is contemplated that the system 1400 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1420a-1420b are in communication with the core network 1430 to provide the EDs 1410a-1410c with voice, data, application, Voice over Internet Protocol (VoIP), or other services. Understandably, the RANs 1420a-1420b or the core network 1430 may be in direct or indirect communication with one or more other RANs (not shown). The core network 1430 may also serve as a gateway access for other networks (such as the PSTN 1440, the Internet 1450, and the other networks 1460). In addition, some or all of the EDs 1410a-1410c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1450.

Although FIG. 14 illustrates one example of a communication system, various changes may be made to FIG. 14. For example, the communication system 1400 could include any number of EDs, base stations, networks, or other components in any suitable configuration.

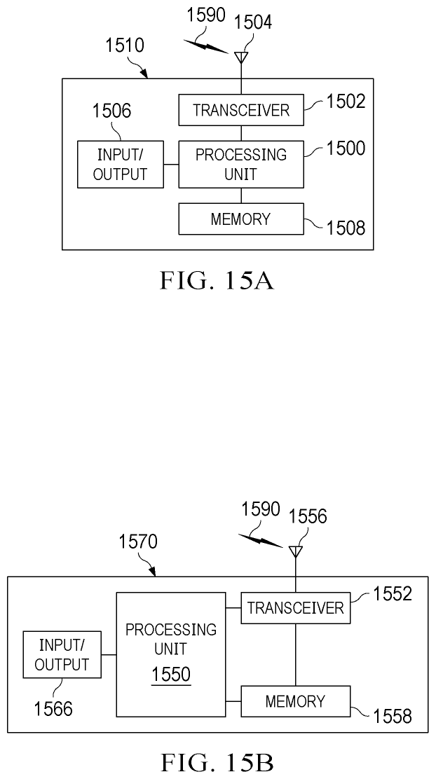

FIGS. 15A and 15B illustrate example devices that may implement the methods and teachings according to this disclosure. In particular, FIG. 15A illustrates an example ED 1510, and FIG. 15B illustrates an example base station 1570. These components could be used in the system 1400 or in any other suitable system.

As shown in FIG. 15A, the ED 1510 includes at least one processing unit 1500. The processing unit 1500 implements various processing operations of the ED 1510. For example, the processing unit 1500 could perform signal coding, data processing, power control, input/output processing, or any other functionality enabling the ED 1510 to operate in the system 1400. The processing unit 1500 also supports the methods and teachings described in more detail above. Each processing unit 1500 includes any suitable processing or computing device configured to perform one or more operations. Each processing unit 1500 could, for example, include a microprocessor, microcontroller, digital signal processor, field programmable gate array, or application specific integrated circuit.

The ED 1510 also includes at least one transceiver 1502. The transceiver 1502 is configured to modulate data or other content for transmission by at least one antenna or NIC (Network Interface Controller) 1504. The transceiver 1502 is also configured to demodulate data or other content received by the at least one antenna 1504. Each transceiver 1502 includes any suitable structure for generating signals for wireless or wired transmission or processing signals received wirelessly or by wire. Each antenna 1504 includes any suitable structure for transmitting or receiving wireless or wired signals. One or multiple transceivers 1502 could be used in the ED 1510, and one or multiple antennas 1504 could be used in the ED 1510. Although shown as a single functional unit, a transceiver 1502 could also be implemented using at least one transmitter and at least one separate receiver.

The ED 1510 further includes one or more input/output devices 1506 or interfaces (such as a wired interface to the Internet 1450). The input/output devices 1506 facilitate interaction with a user or other devices (network communications) in the network. Each input/output device 1506 includes any suitable structure for providing information to or receiving information from a user, such as a speaker, microphone, keypad, keyboard, display, or touch screen, including network interface communications.

In addition, the ED 1510 includes at least one memory 1508. The memory 1508 stores instructions and data used, generated, or collected by the ED 1510. For example, the memory 1508 could store software or firmware instructions executed by the processing unit(s) 1500 and data used to reduce or eliminate interference in incoming signals. Each memory 1508 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 15B, the base station 1570 includes at least one processing unit 1550, at least one transceiver 1552, which includes functionality for a transmitter and a receiver, one or more antennas 1556, at least one memory 1558, and one or more input/output devices or interfaces 1566. A scheduler, which would be understood by one skilled in the art, is coupled to the processing unit 1550. The scheduler could be included within or operated separately from the base station 1570. The processing unit 1550 implements various processing operations of the base station 1570, such as signal coding, data processing, power control, input/output processing, or any other functionality. The processing unit 1550 can also support the methods and teachings described in more detail above. Each processing unit 1550 includes any suitable processing or computing device configured to perform one or more operations. Each processing unit 1550 could, for example, include a microprocessor, microcontroller, digital signal processor, field programmable gate array, or application specific integrated circuit.

Each transceiver 1552 includes any suitable structure for generating signals for wireless or wired transmission to one or more EDs or other devices. Each transceiver 1552 further includes any suitable structure for processing signals received wirelessly or by wire from one or more EDs or other devices. Although shown combined as a transceiver 1552, a transmitter and a receiver could be separate components. Each antenna 1556 includes any suitable structure for transmitting or receiving wireless or wired signals. While a common antenna 1556 is shown here as being coupled to the transceiver 1552, one or more antennas 1556 could be coupled to the transceiver(s) 1552, allowing separate antennas 1556 to be coupled to the transmitter and the receiver if equipped as separate components. Each memory 1558 includes any suitable volatile or non-volatile storage and retrieval device(s). Each input/output device 1566 facilitates interaction with a user or other devices (network communications) in the network. Each input/output device 1566 includes any suitable structure for providing information to or receiving/providing information from a user, including network interface communications.

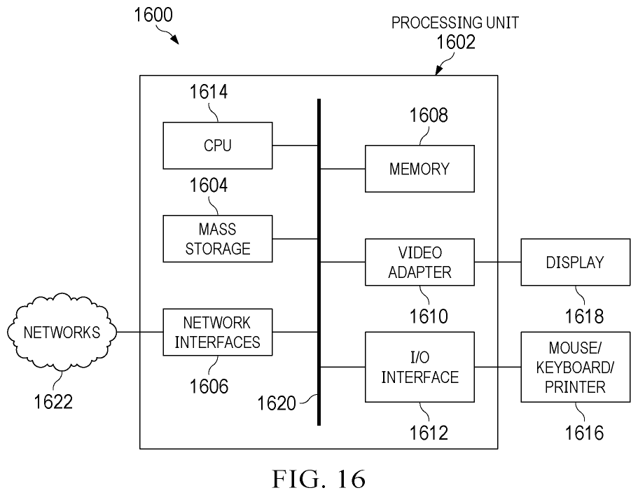

FIG. 16 is a block diagram of a computing system 1600 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, and the like. The computing system 1600 includes a processing unit 1602. The processing unit includes a central processing unit (CPU) 1614, memory 1608, and may further include a mass storage device 1604, a video adapter 1610, and an I/O interface 1612 connected to a bus 1620.

The bus 1620 may be one or more of any type of several bus architectures including a memory bus or memory controller, a peripheral bus, or a video bus. The CPU 1614 may comprise any type of electronic data processor. The memory 1608 may comprise any type of non-transitory system memory such as static random access memory (SRAM), dynamic random access memory (DRAM), synchronous DRAM (SDRAM), read-only memory (ROM), or a combination thereof. In an embodiment, the memory 1608 may include ROM for use at boot-up, and DRAM for program and data storage for use while executing programs.

The mass storage 1604 may comprise any type of non-transitory storage device configured to store data, programs, and other information and to make the data, programs, and other information accessible via the bus 1620. The mass storage 1604 may comprise, for example, one or more of a solid state drive, hard disk drive, a magnetic disk drive, or an optical disk drive.

The video adapter 1610 and the I/O interface 1612 provide interfaces to couple external input and output devices to the processing unit 1602. As illustrated, examples of input and output devices include a display 1618 coupled to the video adapter 1610 and a mouse, keyboard, or printer 1616 coupled to the I/O interface 1612. Other devices may be coupled to the processing unit 1602, and additional or fewer interface cards may be utilized. For example, a serial interface such as Universal Serial Bus (USB) (not shown) may be used to provide an interface for an external device.

The processing unit 1602 also includes one or more network interfaces 1606, which may comprise wired links, such as an Ethernet cable, or wireless links to access nodes or different networks. The network interfaces 1606 allow the processing unit 1602 to communicate with remote units via the networks. For example, the network interfaces 1606 may provide wireless communication via one or more transmitters/transmit antennas and one or more receivers/receive antennas. In an embodiment, the processing unit 1602 is coupled to a local-area network 1622 or a wide-area network for data processing and communications with remote devices, such as other processing units, the Internet, or remote storage facilities.

### Example Process Flowcharts

FIG. 17 depicts an example process 1700. The example process 1700 may be performed by one or more device(s) in accordance with embodiments of the present disclosure, for example a wireless device (e.g., a UE) as depicted and described herein. Optional steps may be depicted in broken (e.g., dashed) lines. The device(s) may include computer-readable (or computer program) code or instructions executing on one or more processors of the device(s). Coding of the software for carrying out or performing the process 1700 is well within the scope of a person of ordinary skill in the art having regard to the present disclosure. The process 1700 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 1700 may be performed by one or more of units or modules (e.g., an integrated circuit) of the device(s), such as field programmable gate arrays (FPGAs) or application-specific integrated circuits (ASICs).

The process 1700 includes a step 1702 of receiving at least one configuration message. In some embodiments, the at least one configuration message is received from a network controller. The at least one configuration message is associated with reporting of at least one UE capability related to at least one AI/ML model or at least one AI/ML-enabled functionality. In some embodiments, the at least one configuration message is an RRC configuration message.

The process 1700 includes a step 1704 of deriving a first value of first resource amount of a first resource type required for at least a first AI/ML model or a first AI/ML-enabled functionality in accordance with the configuration message. In some embodiments, the first AI/ML model or the first AI/ML-enabled functionality in accordance with the configuration message is at least one of the AI/ML model(s) and/or AI/ML-enabled functionality for which UE capabilities/capacities are to be determined. In some embodiments, the first resource type is indicated by or determined based on the at least one configuration message.

The process 1700 includes a step 1706, which may be optional in some embodiments, of deriving a second value of second resource amount of a second resource type required for the first AI/ML model or the first AI/ML-enabled functionality. In some embodiments, the second resource type is another resource type used to support the first AI/ML model or the first AI/ML-enabled functionality. For example, the first resource type may be a processing power or other computational power required the first AI/ML model or AI/ML-enabled functionality, and the second resource type may be a memory required for the first AI/ML model or AI/ML-enabled functionality.

The process 1700 includes a step 1708 of reporting the first value. In some embodiments, the report is provided as a message to the network controller, for example a response message to the at least one configuration message. In some embodiments, reporting includes one or more other portion(s) of additional information, for example a second value of second resource amount of a second resource type, a resource occupation time/timeline, and/or the like as described herein. For example, as depicted and described, the process 1700 includes a step 1710, which may be optional in some embodiments, of reporting, to the network controller, the second value. In some embodiments, the second value is reported in the same report (e.g., a message shared with the first value), or in other embodiments is reported in a different report.

In some embodiments, the process 1700 includes receiving a scheduling. The scheduling may be for the at least one AI/ML model or at least one AI/ML-enabled functionality. In some embodiments, the scheduling is based on a resource occupation timeline associated with the first value. In some embodiments, for example, the scheduling indicates when each AI/ML model or AI/ML-enabled functionality should be run. In some embodiments, the scheduling is embodied by or is based on a resource occupation timeline, for example derived by the network controller based on one or more reported resource occupation times corresponding to the at least one AI/ML model or at least one AI/ML-enabled functionality. The scheduling may be received from a network controller or other network device.

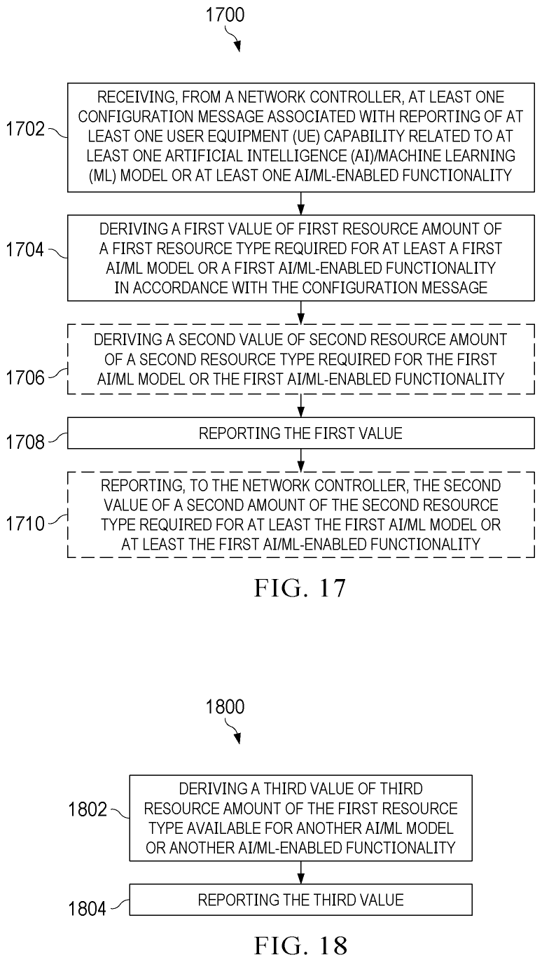

FIG. 18 depicts an example process 1800. The example process 1800 may be performed by one or more device(s) in accordance with embodiments of the present disclosure, for example a wireless device (e.g., a UE) as depicted and described herein. Optional steps may be depicted in broken (e.g., dashed) lines. The device(s) may include computer-readable code or instructions executing on one or more processors of the device(s). Coding of the software for carrying out or performing the process 1800 is well within the scope of a person of ordinary skill in the art having regard to the present disclosure. The process 1800 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 1800 may be performed by one or more of units or modules (e.g., an integrated circuit) of the device(s), such as field programmable gate arrays (FPGAs) or application-specific integrated circuits (ASICs).

In some embodiments, the process 1800 is performed in addition to, or supplementary to, one or more of the steps depicted and described with respect to one or more of the other process(es) described herein. For example, in some embodiments, the process 1800 is performed after the steps, or in conjunction with one or more of the steps, of the process 1700.

The process 1800 includes a step 1802 of deriving a third value of third resource amount of the first resource type available for another AI/ML model or another AI/ML-enabled functionality. For example, the third value may be the measured total resource amount of available first resource type by the wireless device, for example a total available computing power, memory, storage capacity, battery, and/or the like for any resource type.

The process 1800 includes a step 1804 of reporting the third value. In some embodiments, the report is provided as a message to the network controller. The third value is reported together with the first value, and/or the like as described herein.

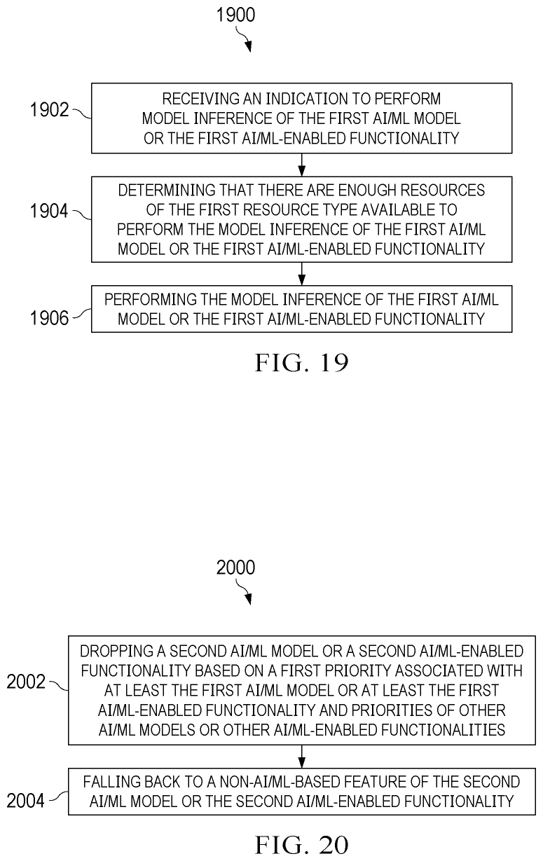

FIG. 19 depicts an example process 1900. The example process 1900 may be performed by one or more device(s) in accordance with embodiments of the present disclosure, for example a wireless device (e.g., a UE) as depicted and described herein. Optional steps may be depicted in broken (e.g., dashed) lines. The device(s) may include computer-readable code or instructions executing on one or more processors of the device(s). Coding of the software for carrying out or performing the process 1900 is well within the scope of a person of ordinary skill in the art having regard to the present disclosure. The process 1900 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 1900 may be performed by one or more of units or modules (e.g., an integrated circuit) of the device(s), such as field programmable gate arrays (FPGAs) or application-specific integrated circuits (ASICs).

In some embodiments, the process 1900 is performed in addition to, or supplementary to, one or more of the steps depicted and described with respect to one or more of the other process(es) described herein. For example, in some embodiments, the process 1900 is performed after the steps, or in conjunction with one or more of the steps, of the process 1700 and/or process 1800.

The process 1900 includes a step 1902 of receiving an indication to perform model inference of the first AI/ML model or the first AI/ML-enabled functionality. In some embodiments the indication is received from a network controller. The indication may trigger the model inference of the first AI/ML model or the first AI/ML-enabled functionality.

The process 1900 includes a step 1904 of determining that there are enough resources of the first resource type available to perform the model inference of the first AI/ML model or the first AI/ML-enabled functionality. In some embodiments, the determination is based on the value of the resource amount of the first resource type required and/or the value of the resource amount of the first resource type available. For example, the determination may be performed as described herein.

The process 1900 includes a step 1906 of performing the model inference of the first AI/ML model or the first AI/ML-enabled functionality. In some embodiments, the performance of the model inference is in response to determining that there are enough resources of the first resource type available. In some embodiments, the performing the model inference comprises running the first AI/ML model and/or the first AI/ML-enabled functionality to derive information associated with resource usage, as described herein, during such model inference (e.g., during running of at least one model).

FIG. 20 depicts an example process 2000. The example process 2000 may be performed by one or more device(s) in accordance with embodiments of the present disclosure, for example a wireless device (e.g., a UE) as depicted and described herein. Optional steps may be depicted in broken (e.g., dashed) lines. The device(s) may include computer-readable code or instructions executing on one or more processors of the device(s). Coding of the software for carrying out or performing the process 2000 is well within the scope of a person of ordinary skill in the art having regard to the present disclosure. The process 2000 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 2000 may be performed by one or more of units or modules (e.g., an integrated circuit) of the device(s), such as field programmable gate arrays (FPGAs) or application-specific integrated circuits (ASICs).

In some embodiments, the process 2000 is performed in addition to, or supplementary to, one or more of the steps depicted and described with respect to one or more of the other process(es) described herein. For example, in some embodiments, the process 2000 is performed after the steps, or in conjunction with one or more of the steps, of the process 1700, process 1800, and/or process 1900.

The process 2000 includes a step 2002 of dropping a second AI/ML model or a second AI/ML-enabled functionality. In some embodiments, the second AI/ML model or second AI/ML-enabled functionality is dropped based on a first priority associated with the first AI/ML model or the first AI/ML-enabled functionality and priorities of other AI/ML models or other AI/ML-enabled functionalities. For example, the second AI/ML model or the second AI/ML-enabled functionality may be of the other AI/ML models or other AI/ML-enabled functionalities, and be associated with a second priority. In some embodiments, the AI/ML model or AI/ML-enabled functionality associated with a lower priority of the first priority and second priority is dropped.

The process 2000 includes a step 2004 of falling back to a non-AI/ML-based feature of the second AI/ML model or the second AI/ML-enabled functionality. In some embodiments, the falling back uses the non-AI/ML-based feature in place of the second AI/ML model or the second AI/ML-enabled functionality.

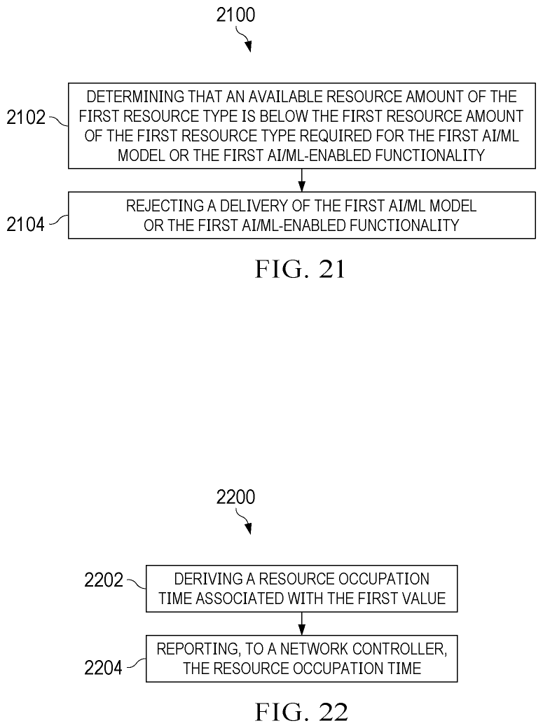

FIG. 21 depicts an example process 2100. The example process 2100 may be performed by one or more device(s) in accordance with embodiments of the present disclosure, for example a wireless device (e.g., a UE) as depicted and described herein. Optional steps may be depicted in broken (e.g., dashed) lines. The device(s) may include computer-readable code or instructions executing on one or more processors of the device(s). Coding of the software for carrying out or performing the process 2100 is well within the scope of a person of ordinary skill in the art having regard to the present disclosure. The process 2100 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 2100 may be performed by one or more of units or modules (e.g., an integrated circuit) of the device(s), such as field programmable gate arrays (FPGAs) or application-specific integrated circuits (ASICs).

In some embodiments, the process 2100 is performed in addition to, or supplementary to, one or more of the steps depicted and described with respect to one or more of the other process(es) described herein. For example, in some embodiments, the process 2100 is performed after the steps, or in conjunction with one or more of the steps, of the process 1700, process 1800, process 1900, and/or process 2000.

The process 2100 includes a step 2102 of determining that an available resource amount of the first resource type is below the first resource amount of the first resource type required for the first AI/ML model or the first AI/ML-enabled functionality. The available resource amount of the first resource type may fluctuate over time, for example as execution of program(s) changes and/or other changes in resource usage and/or availability occur. In this regard, the available resource amount of the first resource type may fall below the amount of the first resource type required for the first AI/ML model or the first AI/ML-enabled functionality at a time after another time at which an amount of the first resource type differed (e.g., was above an amount required for the first AI/ML model or the first AI/ML-enabled functionality.

The process 2100 includes a step 2104 of rejecting a delivery of the first AI/ML model or the first AI/ML-enabled functionality. In some embodiments, the rejecting is in response to determining that the available resource amount of the first resource type is below the first resource amount of the first resource type required for the first AI/ML model or the first AI/ML-enabled functionality. In this regard, the delivery may be rejected, for example, due to changes in available resource amounts dynamically across time.

FIG. 22 depicts an example process 2200. The example process 2200 may be performed by one or more device(s) in accordance with embodiments of the present disclosure, for example a wireless device (e.g., a UE) as depicted and described herein. Optional steps may be depicted in broken (e.g., dashed) lines. The device(s) may include computer-readable code or instructions executing on one or more processors of the device(s). Coding of the software for carrying out or performing the process 2200 is well within the scope of a person of ordinary skill in the art having regard to the present disclosure. The process 2200 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 2200 may be performed by one or more of units or modules (e.g., an integrated circuit) of the device(s), such as field programmable gate arrays (FPGAs) or application-specific integrated circuits (ASICs).

In some embodiments, the process 2200 is performed in addition to, or supplementary to, one or more of the steps depicted and described with respect to one or more of the other process(es) described herein. For example, in some embodiments, the process 2200 is performed after the steps, or in conjunction with one or more of the steps, of the process 1700, process 1800, process 1900, process 2000, and/or process 2100.

The process 2200 includes a step 2202 of deriving a resource occupation time associated with the first value. In some embodiments, the resource occupation time is derived by the wireless device (e.g., a UE), for example where the wireless device derives the first value as described herein. A resource occupation timeline is derivable from the resource occupation time, and/or the combination of the resource occupation time together with one or more other resource occupation times for any number of other AI/ML models or AI/ML-enabled functionalities. In some embodiments, the resource occupation time is derived by the wireless device during performance of model inferencing. In some embodiments, the resource occupation time is a derived, or otherwise measured, based on an amount of time during which an amount of a particular resource type (or multiple resource types) is occupied for performance of model inferencing of one or more AI/ML model(s) and/or one or more AI/ML-enabled functionalities. A resource occupation time may be determined for any resource type and/or using any of the processes described herein. In some embodiments the resource occupation timeline is derived as described below.

The process at 2200 includes a step 2204 of reporting, to the network controller, the resource occupation time. In some embodiments, the resource occupation time is reported together with the first value associated with the first resource type. In some other embodiments, the resource occupation time (and/or resource occupation timeline) is received in response to data received indicating an amount of time that an amount of the first resource type is required for inferencing of an AI/ML model or AI/ML-enabled functionality. As described herein, the resource occupation time (and/or resource occupation timeline) may be received in a single report shared with one or more other portions of information, for example a second value of second resource amount of a second resource type required for the first AI/ML model or the first AI/ML-enabled functionality, available resource amount of the first resource type associated with the wireless device, and/or the first value in accordance with the configuration message, as described herein.

The network controller may perform reporting a resource occupation timeline. In some embodiments, the resource occupation timeline, is included in the same report with one or more other portions of information and/or the like as described herein. In other embodiments, the resource occupation timeline is included in its own report. Reporting may be performed as described herein with respect the process 1700, and for brevity and clarity further repeated discussion is omitted. In other embodiments, the resource occupation timeline is utilized to derive and send a configuration that is reported to the wireless device (e.g., a UE or other terminal device), where the configuration initiates inferencing of the at least one AI/ML model or at least one AI/ML-enabled functionality in accordance with the resource occupation timeline.

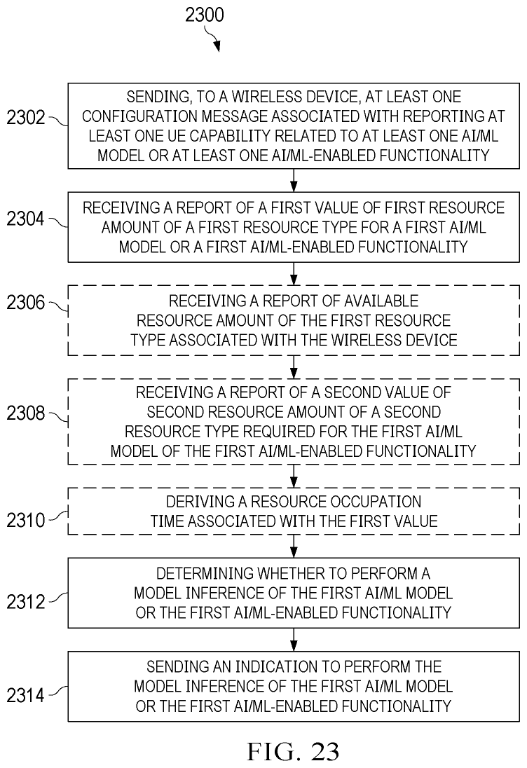

FIG. 23 depicts an example process 2300. The example process 2300 may be performed by one or more device(s) in accordance with embodiments of the present disclosure, for example an electronic device embodying a network controller as depicted and described herein. Optional steps may be depicted in broken (e.g., dashed) lines. The device(s) may include computer-readable code or instructions executing on one or more processors of the device(s). Coding of the software for carrying out or performing the process 2300 is well within the scope of a person of ordinary skill in the art having regard to the present disclosure. The process 2300 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 2300 may be performed by one or more of units or modules (e.g., an integrated circuit) of the device(s), such as field programmable gate arrays (FPGAs) or application-specific integrated circuits (ASICs).

The process 2300 includes a step 2302 of sending at least one configuration message. In some embodiments, the at least one configuration message is sent to a wireless device. In some embodiments, the at least one configuration message is associated with reporting at least one UE capability related to at least one AI/ML model or at least one AI/ML-enabled functionality. For example, the at least one AI/ML model and/or the at least one AI/ML-enabled functionality may be indicated in the at least one configuration message as depicted and described herein. Additionally or alternatively, in some embodiments the at least one UE capability may be indicated in the at least one configuration message, for example corresponding to at least a first resource type to be measured, derived, and/or otherwise reported.

The process 2300 includes a step 2304 of receiving a report of a first value of first resource amount of a first resource type for a first AI/ML model or a first AI/ML-enabled functionality. In some embodiments, the report is received from the wireless device. In some embodiments, the report of the first value is in accordance with the configuration message. For example, in some embodiments, the first resource type is identified in the at least one configuration message as described herein.

The process 2300 includes an optional step 2306 of receiving a report of available resource amount of the first resource type associated with the wireless device. For example, in some embodiments, the report of the available resource amount is received in the same report as the first value. The report may be received in response to the at least one configuration model. In some embodiments, the report is received from the wireless device.

The process 2300 includes an optional step 2308 of receiving a report of a second value of second resource amount of a second resource type required for the first AI/ML model of the first AI/ML-enabled functionality. In some embodiments, the second resource type is a different resource type required to perform model inference. For example, in some embodiments, the first resource type includes a computing power of the wireless device, and the second resource type includes a memory or storage capacity required by the wireless device, to perform model inferencing at a particular wireless device. In some embodiments, the at least one configuration message sent to a wireless device identifies the one or more resource types for which report(s) is/are to be received. In some embodiments, the report is received from the wireless device. The report may be the same report or a different from the report received with respect to the available resource amount of the first resource type and/or the first value. In some embodiments, a compound resource of a plurality of relevant resource types associated with a wireless device is derived and/or recorded, where the compound resource is based on the plurality of the first resource type and the second resource type.

The process 2300 includes an optional step 2310 of deriving a resource occupation time associated with the first value. In some embodiments, the resource occupation timeline is derived during performance of model inferencing. In some embodiments, the resource occupation timeline is a derived based on an amount of time during which resource amount of a particular resource type (or multiple resource types) is occupied for performance of model inferencing of one or more AI/ML model(s) and/or one or more AI/ML-enabled functionalities based on resource occupation times received from the wireless device. A resource occupation time may be represented for any resource type and/or using any of the processes described herein. In some embodiments, a resource occupation timeline is calculated based on all related reports about a particular resource or resource type, for example for an AI/ML model or AI/ML-enabled functionality or a plurality of AI/ML models or AI/ML-enabled functionalities. For example, in some embodiments, the resource occupation timeline indicates each timespan during which a particular resource type is to be occupied by one or more AI/ML models or one or more AI/ML-enabled functionalities for a particular wireless device (e.g., a UE) based on one or more received reports. Such a timeline may be utilized to determine when a particular resource type will be available for one or more particular AI/ML models or AI/ML-enabled functionalities, and/or when to schedule one or more particular AI/ML models and/or AI/ML-enabled functionalities based on resource availability to support such AI/ML models and/or AI/ML-enabled functionalities. In some embodiments, a plurality of resource occupation times are reported to and utilized by a network controller to derive a resource occupation timeline. For example, the network controller may determine a value of a particular resource type that enables performance of AI/ML model or AI/ML-enabled functionality to be completed within a particular time span. In this regard, the wireless device (e.g., a UE) may be configured to report, to the network controller, a plurality of resource occupation times associated with a plurality of values of the first resource type for the at least one AI/ML model or the at least one AI/ML-enabled functionality, where each resource occupation time of the plurality of resource occupation times indicates an amount of time that a resource of the first resource type is utilized at corresponding value of the plurality of values of the first resource type.

In some embodiments, the resource occupation timeline is derived by the network controller, for example from which a report from a wireless device is received including any number of resource occupation times, for the determination without reporting. In some other embodiments, the resource occupation timeline is derived by the network controller in response to data received from the wireless device, for example in one or more reports indicating an amount of the first resource type required or utilized over a time span to run or otherwise inferencing one or more AI/ML models or AI/ML-enabled functionalities. Such data may be represented by the resource occupation times for a number of such one or more AI/ML models or AI/ML-enabled functionalities for a resource type, or multiple resource types. In some embodiments, the resource occupation timeline is utilized to derive and/or report a configuration to the wireless device, where the configuration initiates a model inference schedule based on the resource occupation timeline. In this regard, the resource occupation timeline is utilized to initiate the model inferencing at the wireless device, for example in accordance with the resource occupation timeline. Additionally or alternatively, in some embodiments, the resource occupation timeline is sent to the wireless device, for example as part of a reported configuration.

In some embodiments, the process 2300 includes a step of scheduling one or more models to be run at a wireless device based on a resource occupation time and/or resource occupation timeline. In this regard, the network (e.g., via the network controller) may able to determine when particular resources of particular resource types may be available for use based on one or more resource occupation times and/or resource occupation timelines for one or more of such AI/ML models and/or AI/ML-enabled functionalities. For example, the process 2300 in some embodiments includes scheduling running of the first AI/ML model or the first AI/ML-enabled functionality and a second AI/ML model or a second AI/ML-enabled functionality of at least one artificial intelligence (AI)/machine learning (ML) model or the at least one AI/ML-enabled functionality based on the resource occupation time. Alternatively or additionally, in some embodiments, the process 2300 includes scheduling running of the first AI/ML model or the first AI/ML-enabled functionality and a second AI/ML model or a second AI/ML-enabled functionality of at least one artificial intelligence (AI)/machine learning (ML) model or the at least one AI/ML-enabled functionality based on the resource occupation timeline.

In some embodiments, the resource occupation timeline indicates a combination of models that may be performed over a particular timespan to utilize available resources of a particular resource type without violating a threshold amount associated with the resource type. For example, a pre-configured limit of computational power may be provided as a threshold for a first resource type (e.g., computational power). Resource occupation times associated with a plurality of AI/ML models and/or AI/ML-enabled functionalities may be determined by a wireless device, and reported to the network controller for example. The network controller may, based on such reported resource occupation times, determine timespans during which particular AI/ML models and/or AI/ML-enabled functionalities may be run or otherwise inferenced. In this regard, the scheduling may be performed in accordance with the resource occupation timeline.

The process 2300 includes a step 2312 of determining whether to perform a model inference of the first AI/ML model or the first AI/ML-enabled functionality. In some embodiments, the determination is based on the report of the first value of the amount of the first resource type required for the first AI/ML model or the first AI/ML-enabled functionality. For example, in some embodiments the first value of the amount of the first resource required is compared to at least one threshold as described herein, such as to determine whether the first value of the amount of the first resource type required is less than the at least one threshold.

In some embodiments, the network controller determines whether and/or when to perform a model inference based on a plurality of resource occupation times associated with a plurality of values for a particular, first resource type. For example, in some embodiments a wireless device reports different resource occupation times that decrease as a value of the first resource type increases, such that more resources of the first resource type is utilized for inferencing. In one such context, using 20% of available computational power of a wireless device (e.g., a first value of a first resource type) is reported to correspond to 12 ms of resource occupation time (e.g., a first resource occupation time corresponding to the first value of the first resource type). Similarly, use of 15% of available computational power of the wireless device may be reported to correspond to 15 ms of resource occupation time (e.g., a second value of a first resource type corresponding to a second resource occupation time of the first resource type), and use of 10% of available computational power of the wireless device may be reported to correspond to 18 ms of resource occupation time (e.g., a third value of a first resource type corresponding to a third resource occupation time of the first resource type). In this regard, as a network controller determines a higher value of the first resource type is usable by a wireless device, the resource occupation time required is decreased.

A determination of whether to perform the model inference of the at least one AI/ML model or at least one AI/ML-enabled functionality may include determining which value of the first resource type to utilize, for example to satisfy at least one applicable threshold representing a maximum for the value of the first resource type, a threshold representing a maximum for a resource occupation time corresponding to the at least one AI/ML model or at least one AI/ML-enabled functionality, or both. The network controller may have the flexibility to select a particular value of the first resource type corresponding to a determined resource occupation time desired.

The process 2300 includes a step 2314 of sending an indication to perform the model inference of the first AI/ML model or the first AI/ML-enabled functionality. For example, the indication may indicate the first AI/ML model and/or the first AI/ML-enabled functionality to be performed. Additionally or alternatively, the indication may indicate any other information utilized to perform the model inference, such as a resource operation time or resource operation timeline for the model inference to complete. For example, in some embodiments, the determination is based on any combination of the information described herein, for example a value of an amount of one or more resource types, allowable amounts for one or more AI/ML models and/or AI-ML-enabled functionality. In some embodiments, the indication is sent to the wireless device. In some embodiments, the indication includes or embodies a configuration based on a resource occupation timeline, where the configuration causes the wireless device to model inferencing at a particular time based on the resource occupation timeline.

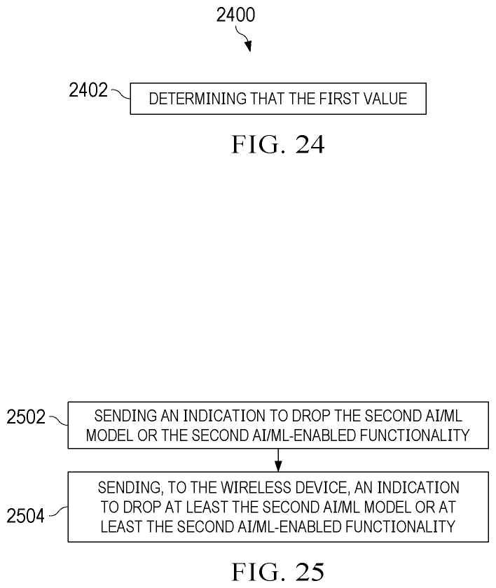

FIG. 24 depicts an example process 2400. The example process 2400 may be performed by one or more device(s) in accordance with embodiments of the present disclosure, for example an electronic device embodying a network controller as depicted and described herein. Optional steps may be depicted in broken (e.g., dashed) lines. The device(s) may include computer-readable code or instructions executing on one or more processors of the device(s). Coding of the software for carrying out or performing the process 2400 is well within the scope of a person of ordinary skill in the art having regard to the present disclosure. The process 2400 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 2400 may be performed by one or more of units or modules (e.g., an integrated circuit) of the device(s), such as field programmable gate arrays (FPGAs) or application-specific integrated circuits (ASICs).

In some embodiments, the process 2400 is performed in addition to, or supplementary to, one or more of the steps depicted and described with respect to one or more of the other process(es) described herein. For example, in some embodiments, the process 2400 is performed after the steps, or in conjunction with one or more of the steps, of the process 2300.

The process 2400 includes a step 2402 of determining that the first value is within an allowed value of the first resource type for the wireless device. In some embodiments, the determination is based at least on the report of the first value. For example, the allowed value of the first resource type may define a threshold for the first resource type that is permitted to be used for the first AI/ML model or the first AI/ML-enabled functionality. In some embodiments, the threshold value is associated with a particular wireless device, or group of wireless devices. The allowed value may be set, for example or by a human actor, or in some embodiments determined based on a dynamic configuration. The first value of the amount of the first resource type required for the first AI/ML model or the first AI/ML-enabled functionality in some embodiments is compared to the allowed value to determine whether the first value is less than the allowed value, thus not violating. In some embodiments, model inferencing is initiated upon such a determination, and not initiated (or model(s) is/are dropped as described herein) in circumstances where the determination indicates that the allowed value would be exceeded (e.g., not within).

FIG. 25 depicts an example process 2500. The example process 2500 may be performed by one or more device(s) in accordance with embodiments of the present disclosure, for example an electronic device embodying a network controller as depicted and described herein. Optional steps may be depicted in broken (e.g., dashed) lines. The device(s) may include computer-readable code or instructions executing on one or more processors of the device(s). Coding of the software for carrying out or performing the process 2500 is well within the scope of a person of ordinary skill in the art having regard to the present disclosure. The process 2500 may include additional or fewer operations than those shown and described and may be carried out or performed in a different order. Computer-readable code or instructions of the software executable by the one or more processors may be stored on a non-transitory computer-readable medium, such as for example, the memory of the device(s). In some embodiments, the process 2500 may be performed by one or more of units or modules (e.g., an integrated circuit) of the device(s), such as field programmable gate arrays (FPGAs) or application-specific integrated circuits (ASICs).

In some embodiments, the process 2500 is performed in addition to, or supplementary to, one or more of the steps depicted and described with respect to one or more of the other process(es) described herein. For example, in some embodiments, the process 2500 is performed after the steps, or in conjunction with one or more of the steps, of the process 2400 and/or the process 2500.

The process 2500 includes a step 2502 of determining to drop a second AI/ML model or a second AI/ML-enabled functionality. In some embodiments, the determination is based on a priority associated with each AI/ML model or AI/ML-enabled functionality, and/or groupings thereof. In some embodiments, the determining is based on a second priority associated with the second AI/ML model or the second AI/ML-enabled functionality, and a first priority associated with the first AI/ML model or the first AI/ML-enabled functionality. For example, in some embodiments, a determination is made to drop the AI/ML model and/or AI/ML-enabled functionality associated with a lesser priority, as described herein.

The process 2500 includes a step 2504 of sending an indication to drop the second AI/ML model or the second AI/ML-enabled functionality. In some embodiments, the indication to drop the second AI/ML model or the second AI/ML-enabled functionality is sent in response to the determination performed at step 2502. In some embodiments, the indication is sent to the wireless device. In some embodiments, the indication triggers the wireless device to perform one or more processes for dropping the second AI/ML model or the second AI/ML-enabled functionality, for example by falling back to a non-AI/ML implementation as described herein.

### Additional Implementation Details

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a configuration message receiving unit/module, a resource value deriving unit/module, a resource value reporting unit/module, a configuration message sending unit/module, a report receiving unit/module, a model inference performance determination unit/module, and/or an indication sending unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method performed by a wireless device, the method comprising:
receiving, by the wireless device from a network controller, a configuration message associated with reporting of a user equipment (UE) capability related to at least one artificial intelligence (AI)/machine learning (ML) model or at least one AI/ML-enabled functionality;
deriving, by the wireless device, a first value of first resource amount of a first resource type required for a first AI/ML model or a first AI/ML-enabled functionality in accordance with the configuration message; and
reporting, by the wireless device to the network controller, the first value.

2. The method of claim 1, wherein the first value comprises a relative value of the first resource amount of the first resource type available in the wireless device.

3. The method of claim 1, wherein the first value comprises a percentage or a portion of the first resource amount of the first resource type available in the wireless device.

4. The method of claim 1, wherein the first value comprises a number of machine-learning processing units (MPUs) associated with the first resource type available in the wireless device.

5. The method of claim 1, wherein the first resource type comprises at least one of computational power, memory, storage, or a battery level.

6. The method of claim 1,
wherein the first AI/ML model represents a model group comprising a set of models to be inferenced together to support another AI/ML-enabled functionality, or
wherein the first AI/ML-enabled functionality is associated with a model group comprising a set of models to be inferenced together to support the first AI/ML-enabled functionality.

7. The method of claim 1, wherein the first resource type comprises a compound resource of a plurality of relevant resource types associated with the wireless device.

8. The method of claim 1, further comprising:
deriving, by the wireless device, a resource occupation time associated with the first value; and
reporting, by the wireless device to the network controller, the resource occupation time.

9. The method of claim 1, further comprising:
deriving, by the wireless device, a second value of second resource amount of a second resource type required for the first AI/ML model or the first AI/ML-enabled functionality; and
reporting, by the wireless device to the network controller, the second value.

10. The method of claim 1, further comprising:
receiving, by the wireless device from the network controller, a scheduling for the at least one AI/ML model or the at least one AI/ML-enabled functionality based on a resource occupation timeline associated with the first value.

11. The method of claim 1, further comprising:
receiving, by the wireless device, an indication to perform model inference of the first AI/ML model or the first AI/ML-enabled functionality;
determining, by the wireless device, that there are enough resources of the first resource type available to perform the model inference of the first AI/ML model or the first AI/ML-enabled functionality; and
in response to the determining that there are enough resources of the first resource type available, performing, by the wireless device, the model inference of the first AI/ML model or the first AI/ML-enabled functionality.

12. The method of claim 1, further comprising:
dropping, by the wireless device, a second AI/ML model or a second AI/ML-enabled functionality based on a first priority associated with the first AI/ML model or the first AI/ML-enabled functionality and priorities of other AI/ML models or other AI/ML-enabled functionalities.

13. The method of claim 12, further comprising:
falling back, by the wireless device, to a non-AI/ML-based feature of the second AI/ML model or the second AI/ML-enabled functionality.

14. The method of claim 1, further comprising:
determining, by the wireless device, that an available resource amount of the first resource type is below the first resource amount of the first resource type required for the first AI/ML model or the first AI/ML-enabled functionality; and
rejecting, by the wireless device in response to determining that the available resource amount of the first resource type is below the first resource amount of the first resource type required for the first AI/ML model or the first AI/ML-enabled functionality, a delivery of the first AI/ML model or the first AI/ML-enabled functionality.

15. The method of claim 1, wherein the reporting the first value comprises:
reporting, by the wireless device to the network controller, a plurality of resource occupation times associated with a plurality of values of the first resource type for the at least one AI/ML model or the at least one AI/ML-enabled functionality,
wherein each resource occupation time of the plurality of resource occupation times indicates an amount of time that a resource of the first resource type is utilized at corresponding value of the plurality of values of the first resource type, and
wherein the plurality of values comprises the first value.

16. A method performed by a network controller, the method comprising:
sending, by the network controller to a wireless device, a configuration message associated with reporting of a user equipment (UE) capability related to at least one artificial intelligence (AI)/machine learning (ML) model or at least one AI/ML-enabled functionality;
receiving, by the network controller from the wireless device, a report of a first value of first resource amount of a first resource type required for a first AI/ML model or a first AI/ML-enabled functionality in accordance with the configuration message;
determining, by the network controller based on the report of the first value, whether to perform a model inference of the first AI/ML model or the first AI/ML-enabled functionality; and
sending, by the network controller to the wireless device, an indication to perform the model inference of the first AI/ML model or the first AI/ML-enabled functionality.

17. The method of claim 16, further comprising:
receiving, by the network controller from the wireless device, a report of an available resource amount of the first resource type associated with the wireless device,
wherein the determining whether to perform the model inference of the first AI/ML model or the first AI/ML-enabled functionality is based on the report of the available resource amount of the first resource type associated with the wireless device.

18. The method of claim 16, wherein the first value comprises a percentage or a portion of the first resource amount of the first resource type available in the wireless device.

19. The method of claim 16, wherein the first AI/ML model or the first AI/ML-enabled functionality is associated with a first priority, the method further comprising:
determining, by the network controller, to drop a second AI/ML model or a second AI/ML-enabled functionality based on a second priority associated with the second AI/ML model or the second AI/ML-enabled functionality and the first priority associated with the first AI/ML model or the first AI/ML-enabled functionality; and
sending, by the network controller to the wireless device, an indication to drop the second AI/ML model or the second AI/ML-enabled functionality.

20. An apparatus comprising:
at least one processor; and
a non-transitory computer readable storage medium storing instructions that, when executed by the at least one processor, cause the apparatus to perform operations including:
receiving, from a network controller, a configuration message associated with reporting of a user equipment (UE) capability related to at least one artificial intelligence (AI)/machine learning (ML) model or at least one AI/ML-enabled functionality;
deriving a first value of first resource amount of a first resource type required for a first AI/ML model or a first AI/ML-enabled functionality in accordance with the configuration message; and
reporting, to the network controller, the first value.
